(19) United States
(12) Patent Application Publication
(10) Pub. No.: US 2024/0364027 A1
(43) Pub. Date: Oct. 31, 2024

(54) METHOD, APPARATUS AND SYSTEM FOR ELECTRICAL CONNECTION

(71) Applicant: AME SYSTEMS (VIC) PTY LTD, Ararat, Victoria (AU)

(72) Inventors: Dean PINNIGER, Ararat, Victoria (AU); Cameron McADIE, Ararat, Victoria (AU); Michael PANG, Ararat, Victoria (AU); Joel D'AMICO, Ararat, Victoria (AU)

(21) Appl. No.: 18/684,945

(22) PCT Filed: Aug. 25, 2022
(86) PCT No.: PCT/AU2022/051047

§ 371 Date: Feb. 20, 2024

(30) Foreign Application Priority Data
Aug. 25, 2021 (AU) 2021902754

(51) Int. Cl. H01R 12/67; H01R 4/2433; H01R 9/03; H01R 13/03; H01R 13/05; H01R 13/52; H01R 13/713

(52) U.S. Cl. CPC H01R 12/675; H01R 4/2433; H01R 9/03; H01R 13/03; H01R 13/05; H01R 13/5208; H01R 13/521; H01R 13/713; H01R 2201/26

(57) ABSTRACT

An apparatus and a system for an insulation-displacement connection adapted for engagement with a multi-core cable for wiring electrical components operatively associated with a vehicle and a trailer.

### RELATED APPLICATIONS

This application claims the priority of Australian Provisional Patent Application No. 2021902754 in the name of AME Systems (Vic) Pty Ltd, which was filed on 25 Aug. 2021, entitled “Method, Apparatus and System for Electrical Connection” and the specification thereof is incorporated herein by reference in its entirety and for all purposes.

### FIELD OF INVENTION

The present invention relates to the field of auto-electrical wiring or cabling, and more particularly to improvements in insulation displacement connections suitable for vehicle applications. In one form, the invention relates to a method and system and apparatus for operative connection of electrical apparatus in and of a towed vehicle including vehicle lighting interconnections. In another form, the invention relates to the manufacture of such a system and apparatus. It will be convenient to hereinafter describe the invention in relation to connecting to an energy source, the lights and other electrical devices in a trailer or the like which can be towed by an automobile, but it should be appreciated that the present invention is not limited to that use, only. In this respect, it is to be understood that references to a “trailer” herein include references to any towed device, such as a caravan, horse-float, boat-trailer, vehicle trailer, freight-trailer, livestock trailer, semi-trailer and/or B-double trailer and the like.

### BACKGROUND ART

Throughout this specification the use of the word “inventor” in singular form may be taken as reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

An insulation-displacement connection or contact (IDC), which may also be known as an insulation-piercing contact, is an electrical connector designed to be connected to the conductor(s) of an insulated cable by a connection process which forces a selectively sharpened blade or blades through the insulation, bypassing the need to strip the conductors of insulation before connecting. When properly made, the connector blade makes contact with the conductor, making a reliable low resistance connection, at least in theory. These types of cable/wiring connections have been in use for many decades, notably in extra-low voltage applications, such as telecommunications, networking and signal connections between parts of an electronic or computer system. However, they are now also used in domestic and industrial applications, including vehicle electrics.

An example prior art attempt at providing an electrical connection of the type mentioned above is disclosed in EP 1313172 (Erich Jaeger GmbH & Co. KG). A cable connector with an insulation displacement or piercing clamps for cable connection is disclosed in which a connector has a base into which the main cable is fed. Internally projecting from the base are pairs of insulation penetrating blade pairs. The top section has a cover and within this is a location that receives square section cables to be coupled. The cores are engaged by the contact blades when the top and base are secured together.

Another example prior art attempt at providing an electrical connection of the type mentioned above is disclosed in U.S. Pat. No. 7,241,165 (Scheer et al.), in which a sectional electrical connector for flat cables includes separable lower and upper horizontal sections formed from a relatively hard synthetic plastic material, at least one electrical contact having a horizontal bus bar portion mounted in the lower section, and a vertical portion extending upwardly toward the upper section, and seal strips integral with and arranged between the sections to seal the space between the sections surrounding the contact vertical portion, the seal strips being formed from a relatively soft synthetic plastic material. In one embodiment, the contact vertical portion comprises an insulation piercing contact for engaging the conductor of an insulated conductor contained in the flat cable. In a second embodiment, the vertical contact portion comprises a pin for connection with one or more components of a printed circuit board.

Another example of prior art attempt at providing an electrical connection as disclosed in Japan Patent No. JP2009245701A (Furukawa Electric Co Ltd et al.), in which a metallic terminal/contact/connector includes a U-shaped section intended to wrap around the wire core conductor strands and form a compressed electrical connection between a crimp terminal and wire core conductors to form a gas-tight, solderless connection, with the ability to be mechanically applied. The U-shaped terminal barrel has been heavily used in the electrical industry for many decades.

Another example prior art attempt at providing an electrical plug and socket connection is disclosed in U.S. Pat. No. 8,894,426 B2 (Erich Jaeger GmbH et al.), which describes a trailer socket connector having double ended terminals embedded in a connector housing into which a standard trailer plug can be connected to one side. In one embodiment, an electrical connector containing wired electrical contacts, wire seals, and weather seal is to be plugged into the opposing side of the of the trailer socket connector to form a complete interconnect allowing the transfer of electrical power from the towing vehicle to the towed trailer. In a second embodiment, the trailer socket connector is connected to a matching trailer plug connector where a plug protrusion interfaces with a spring clamp to inhibit decoupling.

Another example prior art attempt at providing an insulation displacement connection for the purpose of creating string lights is disclosed in U.S. Pat. No. 7,160,140 B10 (GELcore LLC et al.), which describes an insulation displacement connection that can be connected to a flexible multi-cored cable to power LED's. In one embodiment, an insulation displacement connection is integrated into an electronic circuit board containing LED's which are to be connected to a flexible electrical cable. A secondary IDC cover is connected to the circuit board connector to provide an opposing force on the cable, and to interface with the IDC connector housing, locking into place to ensure the cables do not disengage from the IDC terminals. In a second embodiment, the assembled IDC and cable assembly show an over mould which encloses the electronic circuit board and IDC, as well as providing a device for mounting with an appropriate fastener.

Various jurisdictions require that towed vehicles comply with a number of regulatory requirements, including requirements relating to marker lights, directional indicator lights, tail lights, brake lights, and the like. Penalties can be imposed on drivers who are towing vehicles which have malfunctioning lights and/or which do not meet the requirements of the various jurisdictions.

Considering road vehicles with a trailer attached, the user will command the lights (for example, stop, tail, reverse, turn indicators, fog lights) to illuminate based on the state of a switch or other sensing device. For example, the brake pedal activates the brake light switch, which in turn illuminates the brake/stop lights.

If the user intends to manufacture or modify the wiring system on a trailer, the user is generally required to cut into existing cables to make a connection, which must then be adequately electrically insulated. This is often a time consuming and specialised task. Furthermore, a malfunctioning light or damaged cable on trailers is common so even if trailer lights have been checked for correct functioning at the beginning of a journey, those lights can fail during the journey, without the vehicle operator being aware of that failure. A driver may not be aware of the malfunction until alerted to it by another person, and thus be liable to penalties in respect of malfunctioning lights without being aware of any malfunction. If the user is required to rectify the malfunction, the user or other party is generally required to cut into existing cables to make a connection, which must then be adequately electrically insulated. Again, this is often a time consuming and specialised task. With any modification or rectification on the part of a user to build or repair a trailer cabling system, consideration must also be given to spare parts and their availability as well as correct orientation of cabling and connector(s). Given the nature of road travel, the user will also need to consider adequate or appropriate sealing of any electrical connection.

With demands of supply chain schedules, it is also a consideration of users of freight and other vehicles that in the event of any lighting failure from damaged light components or cable, it may be necessary to take the item off line for repairs, for example, to an auto electrician.

Typical industry standard cable assemblies use electrical tape or heat shrinkable tubing to cover cable junctions, but they do not fully seal from water and dust ingress.

Wiring of interconnecting plugs and/or sockets (for example the socket on the vehicle side or the trailer) are typically connected to wires via screw-in terminations and at times with a specific connector that suits the plug or socket connector.

Some variations of the socket connection found on a towing vehicle or towed/trailing vehicle may include a magnetic switch which is used to complete or disconnect a circuit based on the location of the cover (example: open or closed), with the switch having its own dedicated wirable terminals.

The preceding discussion of background art is intended to facilitate an understanding of the present invention only. The discussion is not an acknowledgement or admission that any of the material referred to is or was part of the common general knowledge as at the priority date of the application.

### SUMMARY OF INVENTION

It is an object of the embodiments described herein to overcome or alleviate at least one of the above noted drawbacks of related art systems.

In preferred embodiments the present invention provides the following:

An insulation-displacement connection adapted for engagement with a first multi-core cable for wiring electrical components operatively associated with a vehicle and a trailer wherein the insulation-displacement connection comprises an insulation penetrating electrical contact adapted for engagement with a corresponding set of flexible, stranded insulated core cables of the first multi-core cable wherein the insulation penetrating electrical contact comprises a set of penetrating tabs each set for engaging individual flexible, stranded insulated core cables of the first multi-core cable and each comprising at least two insulation penetrating pins.

Preferably, integral parts of the insulation displacement connection form an upper connector mould assembly, the assembly comprising:
locking mechanisms that are integral with a connector housing for locking with an opposing connector base plate, and;
orientation keying mechanisms for facilitating orientation for assembly with opposing connection portions.

The insulation-displacement connection may be adapted for engagement with at least a first multi-core cable for wiring electrical components operatively associated with a vehicle and a trailer wherein the insulation-displacement connection comprises at least one insulation penetrating contact with insulation penetrating pins uniquely indexed so as to map to a corresponding set of stranded insulated core cables of the first multi-core cable.

Preferably, the at least one insulation penetrating contact comprises:
a plated or un-plated, high strength electrically conductive material;
a conductor attachment area for electrical contact with at least a second connecting single-core or multi-core cable;
a conductor contact area aligning with stranded conductors of the first connecting multi-core cable;
a penetrating tab integral with the insulation penetrating pins, and;
a penetrating point integral with the insulation penetrating pins.

Preferably, the penetrating tab comprises a contact area on one or both of a front face and a rear face of the insulation penetrating contact for making electrical contact with one or more of the stranded insulated core cables of the first multi-core cable.

Preferably, the penetrating tab includes a deflection ramp on either or both a front face and a rear face of the insulation penetrating contact to reduce deflection of the penetrating pins upon piercing contact with the indexed insulated core cables of the first multi-core cable.

Preferably, the penetrating tab includes insulation penetrating pins comprising a high strength copper or alloy thereof.

A preferred embodiment provides an insulation-displacement connection adapted for engagement with a multi-core cable for wiring electrical components operatively associated with a vehicle and a trailer wherein the insulation-displacement connection includes a frame to accommodate the insulation-displacement pins as disclosed herein to;
space respective insulation-displacement connection pins;
retain the insulation-displacement connection pins to provide consistent pin depth;
facilitate locating the insulation-displacement connector into an injection mould tool for manufacturing, and;
reduce the volume of the insulation-displacement connection occupied during manufacture.

The insulation-displacement connection may include a connector frame that comprises;
at least one cavity for seating insulation displacement connections;
a frame cover for maintaining insulation displacement connection location and depth;
a recess for locating a flexible weatherproof seal, and;
a raised rib encircling the seal and contact area of the insulation displacement connection.

The insulation-displacement connection may include a weather seal that is embedded into a recess of the connector frame and/or housing mould to form an upper connector mould assembly upon sealing engagement against a jacket of the first multi-core cable.

The insulation-displacement connection may comprise an integrated flexible weather seal which seals between the connection and individual cable faces of the first multi-core cable.

An integrated flexible weather seal may be configured to encircle insulation penetrating pins protruding from a connection housing mould of the insulation-displacement connection and protrude from the connection housing mould for sealing engagement against a jacket of the first multi-core cable.

The insulation-displacement connection body may comprise:
at least one cable strain relief outlet, and;
at least one single-core or multi-core cable for connection to electrical apparatus.

Preferably, a base plate is configured to engage with the insulation-displacement connection, and comprises at least one longitudinal keyway moulded into the base plate corresponding to a keyway moulded into a first multi-core cable for mating connection between the multi-core cable and the connection base plate.

The at least one keyway may be disposed in an asymmetric configuration with respect to one or more of the first multi-core cable and the connection.

The insulation-displacement connection may comprise;
at least three form factor variations of the insulation displacement connector assembly with respect to the insulation piercing contact index locations to accommodate different connected electrical apparatus comprising one or a combination of left indicator lights, right indicator lights, tail lights, brake lights, reverse lights, marker lights, combination lights, and;
at least two variations of the number of cable outlets to accommodate single or multiple connections to electrical apparatus.

Preferably, the first multi-core cable may comprise;
one or more of flexible, stranded, insulated inner cores that are indexed to match respective penetrating pins;
one or more of flexible, stranded, insulated inner cores that are adapted to conform to size, colour and type characteristics of one or more regulated standards
an outer insulating jacket to house and protect the flexible, stranded, insulated inner cores which is adapted to conform to characteristics of one or more regulated standards;
one of a flat, square, or rectangular profile, adapted to access and connect to the indexed flexible, stranded, insulated cores, and;
a moulded keyway to interface with the insulation displacement connection base plate.

In preferred embodiments there is provided a system for connection of a first multi-core cable for wiring electrical components operatively associated with a vehicle and a trailer, the system comprising:
an insulation-displacement connection as disclosed herein;
a socket associated with the vehicle or the trailer wherein the socket comprises;
at least one side for operatively engaging with a standard trailer plug, and;
at least one side for operatively engaging with a weatherproof sealed connection.

Preferably, a socket connection is provided for use in the system noted above where the socket connection is associated with one of a vehicle or a trailer and comprises:
a main housing of synthetic material for housing multigender terminals corresponding to a form factor so as to make contact with a standard plug connector at one end thereof and an electrical connector at another end thereof;
a magnetic switch operably connectable to electrical contacts protruding from a main connector of the socket, and/or;
an integrated terminal cover and plug connector lock, having a splash proof seal;
a cover pivot pin;
at least one cover torsion spring to either force the cover to seal against the socket housing, or force the cover onto the standard plug connector;
at least two integrated mounting holes for securing the socket connector to a substrate, and;
at least one drainage hole for the release of foreign object debris and/or liquids.

The socket connection may comprise single and/or multigender feedthrough electrical terminals embedded in the socket connection operably associated with mating to the standard plug connector and the weatherproof sealed connector, wherein the feedthrough electrical terminals comprise;
socket-to-Pin gender, or;
Pin-to-Pin gender, and;
at least one central flange for locking into the socket connection housing, and;
plated or un-plated high strength electrically conductive material,

In accordance with preferred embodiments, a socket associated with one of the vehicle or the trailer may comprise a rear housing having a keyway for interfacing with a corresponding keyway of an electrical connector assembly.

Preferred embodiments provide for a connection system for wiring electrical components operatively associated with a vehicle and a trailer, the system comprising:
a connector housing shell of synthetic material;
a keyway for operably interfacing with an inverse keyway of a socket connection;
a contact retainer housing of synthetic material;
a wire seal, which provides an interference fit with the insulation of the connected electrical cable;
a wire seal retainer that inhibits dislodging of the wire seal, and;
an interface seal for providing a weatherproof seal between the socket connector and the weatherproof sealed connector.

A back shell is preferably provided for engagement with a weatherproof sealed connector for use in the system disclosed herein and adapted for providing cable cover and strain relief for at least one multi-core cable, said back shell comprising:
a shell of synthetic material, in at least two segments;
at least one hinge connecting at least two shell segments;
a channel moulded into the shell to lock onto the weatherproof sealed connector;
a ribbed cable grip which forms an interference fit with the at least one multi-core cable, and;
integrated opposing snaps which lock the at least two shell segments together.

The insulation-displacement connection system may comprises at least;
a first multi-core cable, and;
at least one insulation-displacement connector system with insulation penetrating pins, and a keyed base plate, and/or;
at least one trailer socket system, and/or;
at least one back shell accessory.

The insulation-displacement connection may comprise at least one insulation penetrating contact with insulation penetrating pins uniquely indexed so as to map to a corresponding set of stranded insulated core cables of the first multi-core cable. Preferably, the first multi-core cable comprises inner cores that are indexed to match respective penetrating pins.

Preferably, the at least one insulation penetrating contact comprises:
a conductor attachment area for electrical contact with at least a second connecting multi-core cable;
a conductor contact area aligning with conductors of the second connecting multi-core cable, and;
a penetrating tab integral with the insulation penetrating pins.

The penetration tab may comprise a contact area on one or both of a front face and a rear face of the insulation penetrating contact for making electrical contact with one or more of the stranded insulated core cables of the first multi-core cable.

The penetrating tab may include a deflection ramp on either or both a front face and a rear face of the insulation penetrating contact to reduce deflection of the penetrating pins upon piercing contact with the indexed insulated core cables of the first multi-core cable.

The insulation-displacement connector of preferred embodiments may comprise an integrated flexible weather seal which seals between the connector and individual cable faces of the multi-core cable.

Preferably, the weather seal is configured to encircle insulation penetrating pins protruding from a connector housing mould of the insulation-displacement connector and protrude from the connector housing mould for sealing engagement against a jacket of the multi-core cable.

Preferably, the weather seal is embedded into a recess of the connector housing mould to form an upper connector mould assembly upon sealing engagement against the jacket of the multi-core cable.

Embodiments of the present invention provide a system for wiring electrical components operatively associated with a vehicle and a trailer with at least one multi-core cable, the system comprising:
an insulation-displacement connection as disclosed herein, and;
a socket connection as disclosed herein associated with one of the vehicle or the trailer wherein the socket connection comprises one or a combination of;
an electrical connector assembly comprising a main housing with at least one internal wire seal and a wire seal retainer bonded to the main housing to form an interference fit with the wire seal to deter foreign object debris and/or liquid ingress and;
drainage holes for the release of foreign object debris and/or liquids.

The insulation-displacement connection of preferred embodiments comprises at least one longitudinal keyway moulded into the multi-core cable and a corresponding keyway moulded into an insulation-displacement connector for mating connection between the multi-core cable and the connector wherein uniquely indexed insulation penetrating pins of the connector are mapped to a corresponding set of stranded insulated core cables of the multi-core cable.

Preferably, the at least one keyway is disposed in an asymmetric configuration with respect to one or more of the multi-core cable and the connector.

Preferred embodiments may further comprise a socket associated with one of the vehicle or the trailer wherein the socket comprises a rear housing having a keyway for interfacing with a corresponding keyway of an electrical connector assembly formed by the system as disclosed herein.

Preferably, the insulation-displacement connection includes insulation penetrating pins comprising a high strength copper or an alloy thereof.

Preferably, the insulation-displacement connection comprises:
an insulation penetrating electrical contact adapted for connecting engagement with a corresponding set of stranded insulated core cables of the multi-core cable wherein the insulation penetrating electrical contact comprises a set of penetrating tabs each set for engaging individual stranded insulated core cables of the multi-core cable and each comprising at least two insulation penetrating pins.

Preferred embodiments provide a connection system for engagement with at least a first multi-core cable for wiring electrical components operatively associated with a vehicle and a trailer, the system comprising:
a socket associated with one of the vehicle or the trailer wherein the socket comprises a magnetic switch operably connectable to electrical contacts protruding from a main connector of the socket, and;
an electrical connector assembly configured to a corresponding form so as to make a sealing contact with the socket and the electrical contacts.

In general, the invention provides an insulation-displacement connection adapted for engagement with at least a first multi-core cable for wiring electrical components operatively associated with a vehicle and a trailer wherein the insulation-displacement connection comprises at least one insulation penetrating contact with insulation penetrating pins uniquely indexed so as to map to a corresponding set of stranded insulated core cables of the first multi-core cable.

Advantageously, the insulation-displacement connection may then facilitate electrical connection to an electrical apparatus such as lighting and the like through a single-core cable or single-core cable embedded within the multi-core cable.

Preferably, the first multi-core cable comprises inner cores that are indexed to match respective penetrating pins.

Preferably, the at least one insulation penetrating contact comprises:
a conductor attachment area for electrical contact with at least a second connecting single-core or multi-core cable;
a conductor contact area aligning with conductors of the second connecting single-core or multi-core cable, and;
a penetrating tab integral with the insulation penetrating pins.

Preferably, the penetration tab comprises a contact area on one or both of a front face and a rear face of the insulation penetrating contact for making electrical contact with one or more of the stranded insulated core cables of the first multi-core cable.

Preferably, the penetrating tab includes a deflection ramp on either or both a front face and a rear face of the insulation penetrating contact to reduce deflection of the penetrating pins upon piercing contact with the indexed insulated core cables of the first multi-core cable.

Generally, the invention also provides an insulation-displacement connector adapted for engagement with a multi-core cable for wiring electrical components operatively associated with a vehicle and a trailer wherein the insulation-displacement connector comprises an integrated terminal chamber and flexible weather seal which seals between the connector and individual cable faces of the multi-core cable.

Preferably, the weather seal is configured to encircle insulation penetrating pins protruding from a connector housing mould of the insulation-displacement connector and protrude from the connector housing mould for sealing engagement against a jacket of the multi-core cable.

Preferably, the weather seal is embedded into a recess of the connector housing mould to form an upper connector mould assembly upon sealing engagement against the jacket of the multi-core cable.

Preferably, the terminal chamber contains a raised lip or rib encircling the insulation penetrating pins before, after, or between the weather seal to form a rigid uniform mechanical seal between the jacket of the flat multi-core cable and the connector housing.

Preferred embodiments of the invention provide a system for locating and/or seating the insulation-displacement pins prior to/during manufacture to aid correct positioning of insulation-displacement connector pins, and provide a means of terminal position assurance to keep insulation-displacement connector pins in place, and ensure correct depth of insulation-displacement connector pins is maintained as claimed in claim 16.

In one embodiment there is provided a system comprising:
at least a base frame with indexed insulation-displacement connector positions, and;
a top frame which may be connected to the base frame to hold insulation-displacement connector terminals in position, and/or;
mechanical latches to hold insulation-displacement connector terminals in position.

In general, the invention also provides a system for insulation-displacement connection of a multi-core cable for wiring electrical components operatively associated with a vehicle and a trailer wherein the insulation-displacement connection comprises at least one longitudinal keyway moulded into the multi-core cable and a corresponding keyway moulded into an insulation-displacement connector for mating connection between the multi-core cable and the connector wherein uniquely indexed insulation penetrating pins of the connector are mapped to a corresponding set of stranded insulated core cables of the multi-core cable.

Preferably, the at least one keyway is disposed in an asymmetric configuration with respect to one or more of the multi-core cable and the connector.

Preferred embodiments of the invention provide a system to ensure that the two main connectors that make up the Insulation-displacement connector connected to a multi-cored cable are able to be connected in a single orientation. This may be achieved by matching and opposing keyways on two main connectors.

Generally, the invention also provides an insulation-displacement connection adapted for engagement with a multi-core cable for wiring electrical components operatively associated with a vehicle and a trailer wherein the insulation-displacement connection includes insulation penetrating pins comprising a high strength copper or alloy thereof.

Preferably, the high strength copper alloy comprises one or a combination of elements typically from the Nonmetals (N), Alkali Metals (AM), Alkaline Earth Metals (AEM), Transition Metals (TM), Post-Transition Metals (PTM), or Metalloid (M) groups of the periodic table of elements such as:
Copper;
Nickel;
Aluminium;
Tin;
Lead;
Zinc;
Beryllium;
Silver;
Gold;
Palladium;
Cobalt;
Iron;
Niobium;
Phosphorus;
Or the like;
wherein the combination is alloyed in any combination between about 0% to about 100% of any of the metals.

Generally, the invention also provides an insulation-displacement connection adapted for engagement with a multi-core cable for wiring electrical components operatively associated with a vehicle and a trailer wherein the insulation-displacement connection comprises:
an insulation penetrating electrical contact adapted for connecting engagement with a corresponding set of stranded insulated core cables of the multi-core cable wherein the insulation penetrating electrical contact comprises a set of penetrating tabs each set for engaging individual stranded insulated core cables of the multi-core cable and each comprising at least two insulation penetrating pins.

Generally, the invention may also provide a system for insulation-displacement connection of a multi-core cable for wiring electrical components operatively associated with a vehicle and a trailer, the system comprising:
an insulation-displacement connector as claimed in claim 6, 7 or 8, and;
a socket associated with one of the vehicle or the trailer wherein the socket comprises one or a combination of;
   an electrical connector assembly comprising a main housing with at least one internal wire seal and a wire seal retainer bonded to the main housing to form an interference fit with the wire seal to deter foreign object debris and/or liquid ingress and;
   an interface seal for sealing between the electrical connector assembly and the socket connector to form an interference fit to deter foreign object debris and/or liquid, and;
   drainage holes for the release of foreign object debris and/or liquids.

Preferably, the system further comprises a socket associated with one of the vehicle or the trailer wherein the socket comprises a rear housing having a keyway for interfacing with a corresponding keyway of an electrical connector assembly.

Generally, the invention also provides a connector system for engagement with at least a first multi-core cable for wiring electrical components operatively associated with a vehicle and a trailer, the system comprising:
a socket associated with one of the vehicle or the trailer wherein the socket comprises a magnetic switch operably connectable to electrical contacts protruding from a main connector of the socket, and;
an electrical connector assembly configured to a corresponding form so as to make a sealing contact with the socket and the electrical contacts.

A first aspect of embodiments disclosed herein addresses the problem of the time-consuming manufacturing of trailer wiring systems which generally require a main multi-cored cable to be cut into, and the inner cables ‘tapped’ to make a connection to other electrical apparatus such as lights and the like, which must then be adequately electrically insulated. This problem is addressed by a preferred solution involving flat multi-cored cable and specifically indexed insulation penetrating pins that correspond to the intended multi-core cable connection. Advantageously, this means that the manufacturer does not need to cut into the multi-cored cable, and/or cut into the inner cores to make a ‘tapped’ connection, and/or does not need to insulate the tapped connection, and/or does not need to insulate the multi-cored cable.

A second aspect of embodiments disclosed herein relates to the problem of round multi-cored cable needing to be cut into to make a ‘tapped’ connection. This problem is addressed by a preferred solution involving the manufacture of a flat multi-cored cable, where the inner cores are indexed in a particular sequence, and an insulation penetrating connection having a matching index of the penetrating connection to the intended cable connection. Advantageously, this allows for the flat multi-cored cable and specific variations of the indexed insulation penetrating connectors being manufactured as standard parts, and assembled quickly to make the ‘tapped’ connection without having to cut into the multi-cored cable.

A third aspect of embodiments of the present invention disclosed herein relates to a problem similar to that described above being the requirement for a user or 2^{nd} or 3^{rd} party to repair and rectify malfunctions, especially in remote locations where expert assistance is limited or unavailable. For example, the requirements for roadside assistance, automotive electrician, and the like. This problem is addressed by a preferred solution involving a rapid installation connection system having the ability to make connection to a main trailer cable that is operative for the user to quickly and correctly make contact with the desired cable without the need for specialised qualification. The advantages of this are that the user does not need to rely on having access to 2nd or 3rd party assistance in the event of malfunction or damage. The user may spend less time off the road to rectify breakdown problems reducing transfer time and cost.

A fourth aspect of preferred embodiments of the invention disclosed herein relates to the problem of sealing connections to protect them from foreign objects, debris, and liquids that, as a consequence, lead to malfunctions. This problem is addressed by a preferred solution involving an indexed insulation penetrating connection having an integrated flexible weather seal which seals between the connector and cable faces. Advantageously, this allows for a user to correctly install the connector and be assured that the connection is sealed without any other specialised materials.

A fifth aspect of preferred embodiment of the present invention disclosed herein relates to the problem of an insulation penetrating connection system being installed backwards, creating the wrong connection. This problem is addressed by a preferred solution involving a keyway moulded longitudinally into the flat multi-cored cable, and the corresponding keyway moulded into the connector. Advantageously, this requires that the connection system can only fit together correctly on the flat cable one way reducing incorrect orientation.

A sixth aspect of preferred embodiments of the present invention disclosed herein relates to a similar problem as noted above with respect to an indexed insulation penetrating connection system being installed backwards, creating the wrong connection. Accordingly, this problem is addressed by a preferred solution involving asymmetrical keyways on the indexed connectors. Advantageously, this requires that the connector system can only be correctly installed onto the flat multi-cored cable in one orientation, and the connector system can only be installed to itself in one orientation.

A seventh aspect of embodiment of the present invention disclosed herein relates to the problem of penetrating a flat multi-cored cable to make contact with the inner stranded core conductors where forked type insulation displacement connections were not suitable, without bending the contacts, and having the connection made to a connecting wire. This problem is addressed by a preferred solution involving an electrical connection made from a high strength copper alloy able to be mechanically or otherwise attached to a connecting wire, that incorporates insulation penetrating pins. Advantageously, this provides an electrical contact that can be attached to a connecting wire, moulded into housing, and forced into the cable, making contact without bending the penetrating pins.

An eighth aspect of embodiments of the present invention disclosed herein relates to a similar problem to that described above relating to penetrating the flat multi-cored cable to make contact with the inner stranded core conductors where forked type insulation displacement connections are not suitable, and to increase the strand contact area for better conductivity and/or less electrical power transfer loss. This problem is addressed by a preferred solution involving having two penetrating pins per electrical contact. Advantageously, this provides for increased conductivity and/or less electrical power transfer loss of each insulation penetrating connection.

A ninth aspect of preferred embodiments of the present invention disclosed herein relates to the problem of connecting switch contacts to complete or disconnect (make or break) a circuit based on the location of a cover in a sealed connector. This problem is addressed by a preferred solution involving an industry standard plug or socket connection (e.g., AS/NZS 2513, AS/NZS 4177.5, ISO1185, ISO1724, ISO3731, SAE J560, SAEJ2863 and the like) on a towing vehicle and/or towed vehicle with a sealed interfacing connector containing regular connections (per the standards), with the option of having switch contacts integrated into the same sealed connector. Advantageously, this may ensure that the connection is sealed, easily plugged or unplugged, and uses a reliable connection method other than screw-in type connections.

A tenth aspect of embodiments of the present invention disclosed herein relates to the problem of connection to power and signal, and switch contacts in an electrical connector. This problem is addressed by a preferred solution involving having an electrical connector interfacing with a trailer socket for simple weatherproof assembly. The advantages of this are the sealed electrical connection to the contacts between the towing vehicle and the towed vehicle as well as having two or more additional electrical contacts attached to a magnetic switch on the trailer socket assembly, and the matching electrical contact within the electrical connector, allowing for an electrical circuit to be made through the electrical connector, trailer socket, and magnetic switch.

An eleventh aspect of embodiments of the present invention disclosed herein relates to the problem of productivity in the manufacturing process of the insulation piercing connector assembly wherein cavity shutoff around the insulation piercing terminal may be difficult, slowing the cycle time. This problem is addressed by a solution involving a single or multi piece terminal frame where each insulation piercing terminal is assembled into its particular index in the frame. The frame acts as a shutoff around the terminals, holds the terminals in vertical and horizontal position, isolates terminals from adjacent terminals, and promotes terminal depth assurance, as well as having terminal position assurance so that the terminals cannot back out of the frame. Location geometry on the frame mates with the inverse geometry of the injection mould cavity ensuring X, Y and Z positioning.

A twelfth aspect of embodiments of the present invention disclosed herein relates to the problem of protecting exposed inner cables of the first multicore wherein the jacket of the first multicore has been removed to allow the inner core wires to be assembled into a connector, thus exposing the inner core cables as they transition from a multicore to a connector. This problem is addressed by a solution involving a single or multi piece shell made from synthetic material which clamps on to the connector and the remaining multicore jacket, creating a rigid joint encircling the exposed cables, and interlocking with itself to prevent it from becoming loose, thus creating an imitation extension of the multi core cable jacket.

Other aspects and preferred forms are disclosed in the specification and/or defined in the appended claims, forming a part of the description of the invention.

Embodiments of the present invention stem from a realization that there are limited options for connectivity and scalability of customisable trailer wiring, being that to add or rectify connections for lighting and the like, an existing trailer wiring has to be time consumingly modified, and is not simply a plug-and-play modular system.

Further advantages provided by the present invention comprise the following:
A manufacturer can reduce labour time spent on manufacturing trailer electrical wiring, such as for example, an electrical wiring harness for a trailer.
The customisable nature of the product allows for in situ repair or customisation by the user with minimal requirement for specific tools.
Reduces the need for engineering/design support for maintain vehicles on road.
Reduces the possibility of incorrect connector orientation.
Provides an environmental seal connection system
Provides a system of scalable connectivity
The user or operator may be able to install a new connection in situ with off-the-shelf spare parts.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

FIG. 1 is an isometric view of a keyed flat multi-cored cable in accordance with an embodiment of the invention.

FIG. 2 shows a further embodiment of the invention illustrating the upper part of an insulation penetrating connector with a single cable outlet.

FIG. 3 shows another embodiment of the invention illustrating the upper part of an insulation penetrating connector with double cable outlet.

FIG. 4 shows an embodiment of the invention illustrating the lower part of an insulation penetrating connector.

FIG. 5 is an exploded or unassembled view of an embodiment of the invention illustrating keyways, insulation penetrating pins, and locking latches prior to engagement with each other.

FIG. 6 shows an embodiment of the invention illustrating a complete insulation penetrating connection assembly in its final locked position.

FIG. 7 shows the assembly of FIG. 6 with a connector and cable keyways engaged, as well as the connector locks.

FIG. 8 shows another embodiment of the invention illustrating the frame assembly with insulation penetrating pins and cable.

FIG. 9 shows a cross sectional view of the frame assembly of FIG. 8 with insulation displacement pin inserted into the frame.

FIG. 10 shows an embodiment of the invention with a view illustrating an insulation penetrating electrical contact, with cable crimp.

FIG. 11 shows an embodiment of the invention with another view illustrating an insulation penetrating electrical contact, without cable crimp.

FIG. 12 shows an embodiment of the invention with yet another view illustrating an insulation penetrating electrical contact, with deflection ramps.

FIG. 13 is a view of an embodiment of the invention showing an insulation penetrating connector assembly on installation with a round socket assembly with flat multi-cored cable and strain relief shell.

FIG. 14 is a side view of an embodiment of the invention illustrating with a round style socket assembly with flat multi-cored cable.

FIG. 15 is a rear view of an embodiment of the invention illustrating a socket connector assembly with circular electrical connector installed.

FIG. 16 is a front view of the socket connector assembly of FIG. 15.

FIG. 17 is a rear view of the socket connector assembly of FIG. 15.

FIG. 18 is a view of the circular electrical connector assembly of FIG. 15.

FIG. 19 is a cross sectional view of the circular electrical connector assembly of FIG. 15.

FIG. 20 is a cross sectional view of the circular electrical connector assembly of FIG. 15 with electrical contact and cable inserted.

FIG. 21 is a side view of an embodiment of the invention illustrating a rectangular/flat style socket assembly with flat multi-cored cable.

FIG. 22 is a rear view of the socket connector assembly of FIG. 21.

FIG. 23 is a view of a rectangular/flat style electrical connector assembly of FIG. 21 with flat cable attached.

FIG. 24 is a rear view of the rectangular/flat style electrical connector assembly of FIG. 21.

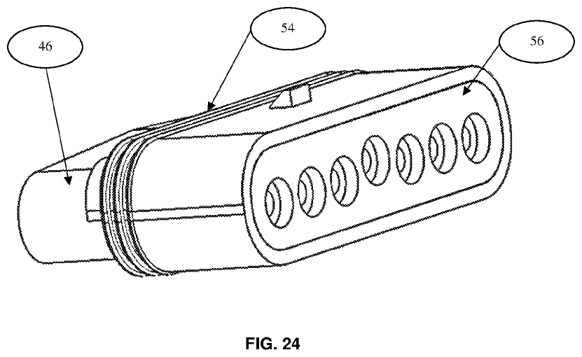

FIG. 25 is a cross sectional view of the rectangular/flat style electrical connector assembly of FIG. 21 with electrical contact inserted.

FIG. 26 is a rear view of the rectangular/flat style electrical connector assembly of FIG. 21 showing a seal retainer.

FIG. 27 is a rear view of the rectangular/flat style electrical connector assembly of FIG. 21 with integrated switch contacts.

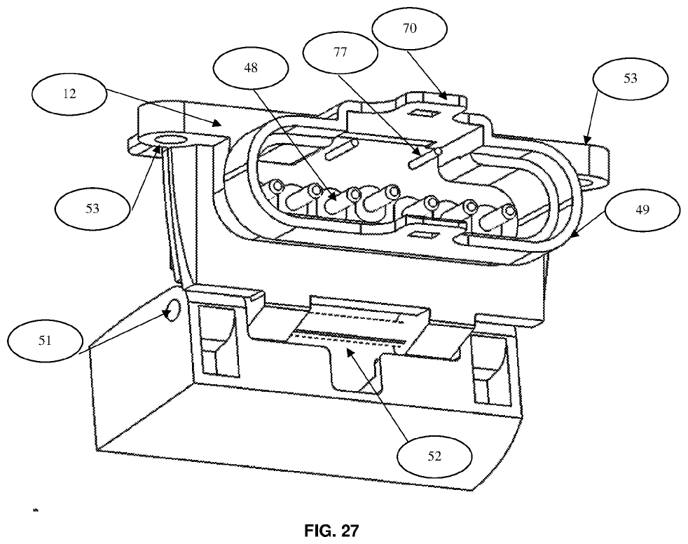

FIG. 28 is an exploded rear view of the socket connector assembly of FIG. 21, with allowance for switch contacts.

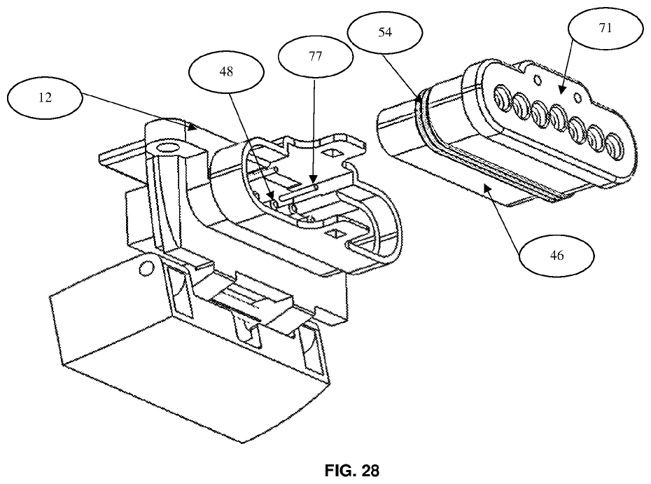

FIG. 29 is a front face view of an insulation displacement connector in accordance with an embodiment of the invention showing resultant pin deflection.

FIG. 30 is a view of an exemplary insulation piercing contact in accordance with an embodiment of the invention connected to the inner cores of a multi-cored cable, with cables exiting on one side.

FIG. 31 is a view of an exemplary insulation piercing contact in accordance with an embodiment of the invention connected to multiple inner cores of a multi-cored cable, with cables exiting on one side.

FIG. 32 is a view of an exemplary insulation piercing contact in accordance with an embodiment of the invention connected to multiple inner cores of a multi-cored cable, with cables exiting on both sides.

FIG. 33 is a view of an exemplary insulation piercing contact in accordance with an embodiment of the invention connected to a single-cored cable, with the cable exiting on one side.

FIG. 34 is a view of an exemplary insulation piercing contact in accordance with an embodiment of the invention connected to multiple single-cored cables, with cables exiting on one side.

FIG. 35 is a view of an exemplary insulation piercing contact in accordance with an embodiment of the invention connected to multiple single-cored cables, with cables exiting on both sides.

FIG. 36 shows a schematic of an exemplary test method suitable for testing insulation displacement connectors in accordance with the invention including submersion and testing equipment connection.

FIG. 37 is a view of an exemplary back shell shown in its open form in accordance with an embodiment of the invention.

### DETAILED DESCRIPTION

A component list of reference numerals used in the accompanying drawings follows.
1—flat multi-cored cable
2—stranded insulated core cable
3—insulating jacket
4—moulded keyway
5—connector mould
6—connecting multi-cored cable
7—insulation penetrating electrical contact
8—weather seal
9—connector base mould
10—asymmetrical keyways
11—cable locating keyway
12—flat trailer connector
13—conductor crimp barrel
14—penetrating tab
15—penetrating point
16—contact area
17—wire contact area
18—deflection ramp
19—strain relief back shell
20—electrical connector assembly
21—trailer socket assembly
22—socket cover
23—plug retainer
24—mounting holes
25—lock
26—fulcrum pin
27—return spring
28—socket contact
29—pin contact
30—socket shell
31—weather seal
32—keyway
33—pin contact
34—connector housing
35—keyway
36—interface weather seal
37—lock
38—wire seal retainer
39—wire seal
40—contact retainer
41—contact shaft
42—wire sealing section
43—contact locator insert
44—electrical contact
45—flat connector cover
46—flat trailer electrical connector
47—weather seal
48—electrical contact
49—shroud
50—lock
51—fulcrum pin
52—return spring
53—mounting hole
54—interface weather seal
55—lock
56—cable seal
57—electrical contact
58—cable sealing area
59—connector mould recess
60—upper connector mould assembly
61—locked position
62—housing
63—drainage holes
64—electrical contact position insert
65—keyway
66—strain relief shell
67—electrical contact
68—keyway
69—keyway
70—locking tabs
71—cable seal retainer
72—connector housing
73—terminal retainer
74—contact shaft
75—flange
76—flange
77—switch contacts
78—idc frame
79—idc frame cover
80—chamber rib
81—salt water with dye
82—exposed wire end
83—container
84—device under test
85—test meter
86—deflected pin
87—snap
88—snap receiver
89—connecting single-cored cable
90—core of connecting multi-cored cable
91—cable strain relief outlet
92—back shell body
93—hinge
94—snap lock
95—snap receiver
96—snap lock
97—snap receiver
98—locking groove
99—ribbing

### Construction

Embodiments of the present invention, in one form, pertain to a connection system containing a specifically indexed electrical Insulation Displacement Connection (IDC) interfacing with a matching indexed multi-cored cable to make a fixed electrical connection for power distribution systems.

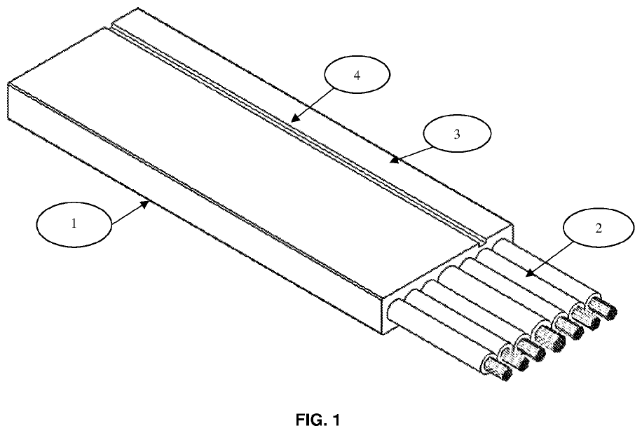

As is illustrated in FIG. 1, a flat multi-cored cable 1 according to a preferred embodiment of the present invention contains various inner cores 2 of insulated flexible stranded cable with colour, size and material according to various jurisdictions, covered with a soft insulating jacket 3 comprising a longitudinal keyway 4 which runs the entire length of the cable 1.

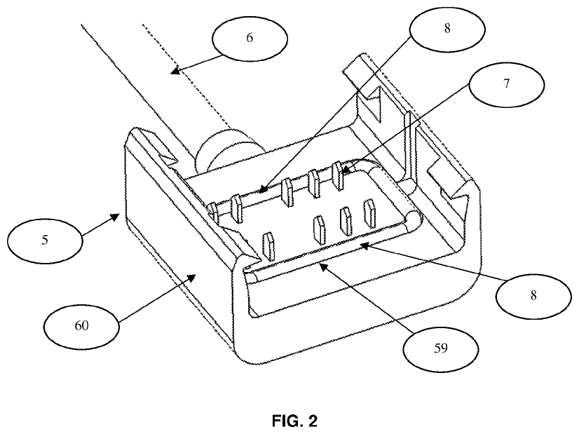

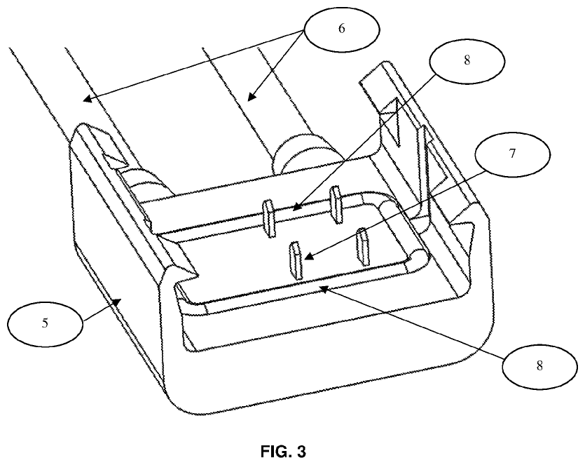

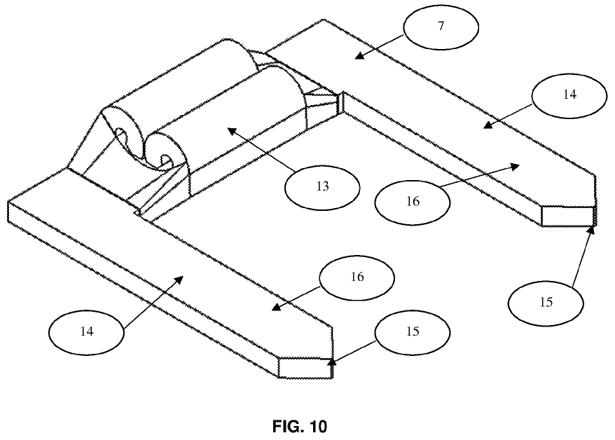

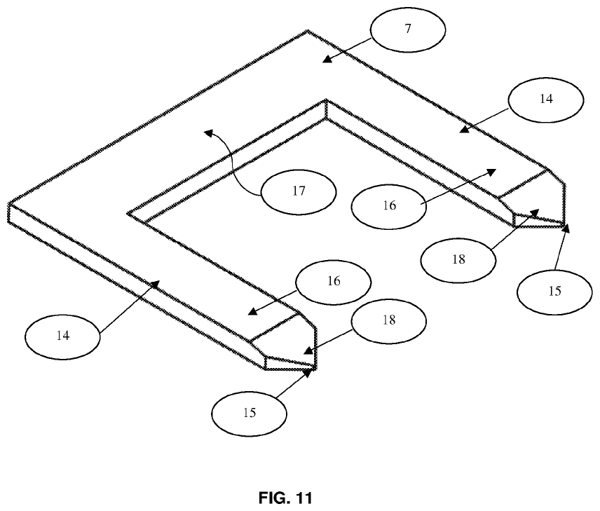

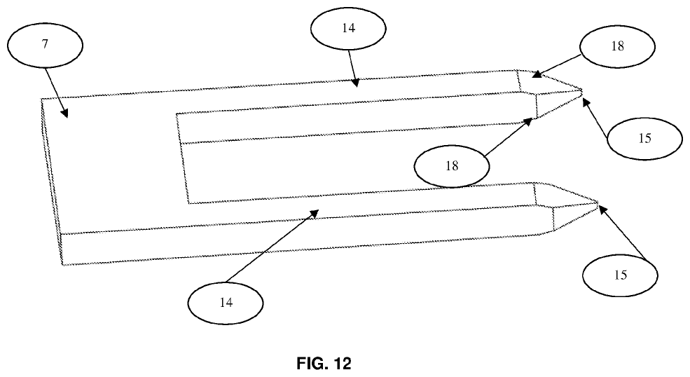

An insulation penetrating contact 7 is shown in FIGS. 2, 3, 5, 8, and 9 with an exemplary enlarged view shown in FIGS. 10, 11, and 12. According to preferred embodiments, the insulation penetrating contact 7 is constructed from metal sheet of high strength copper alloy and formed into a U-shape to produce three main sections. A conductor attachment area such as a conductor crimp barrel 13 (as shown in FIG. 10 in its final crimped form) or a flat contact area 17 (as shown in FIG. 11) or the like is located in a central position axially in line with the connecting wire 89 or 90 (not shown). At each end of and perpendicular to the conductor attachment area is a penetrating tab 14 terminating with a penetrating pin or point 15 (best shown in FIG. 10). Both tabs 14 as shown face the same direction to provide two symmetrical insulation penetrating points 15 into the same inner cable core 2.

The penetrating tab 14 and penetrating point 15 may or may not have a deflection ramp 18, as with the embodiment shown in FIG. 11, on either or both the front and rear face of the penetrating contact 7 to reduce deflection of the penetrating tab 14.

The penetrating tab 14 contains a contact area 16 on both front and rear faces of the penetrating contact 7 to make contact with the strands of flat multi-cored cable 1 and its inner cores 2.

The insulation penetrating electrical contact 7 may comprise un-plated base material or may be plated fully or selectively with Tin, Nickel, or the like to deter corrosion.

As is illustrated in FIG. 2, a multi-cored cable 6 is attached to the wire contact area 13 or 17 (not visible in FIG. 2) of an insulation penetrating electrical contact 7, allowing energy transfer from the contact 7 to the wire. Multiple electrical contacts 7 are embedded and encapsulated in a polymer connector housing mould 5 with the insulation penetrating contact 7 protruding from the connector mould 5.

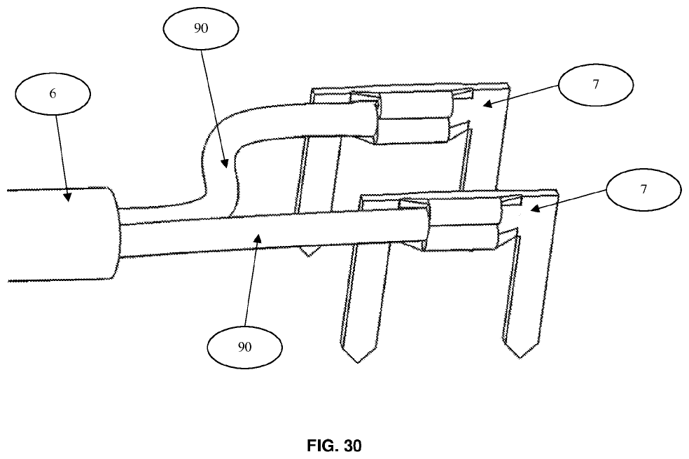

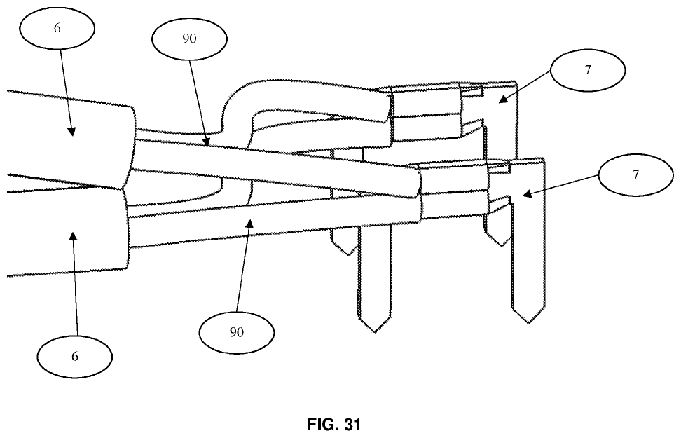

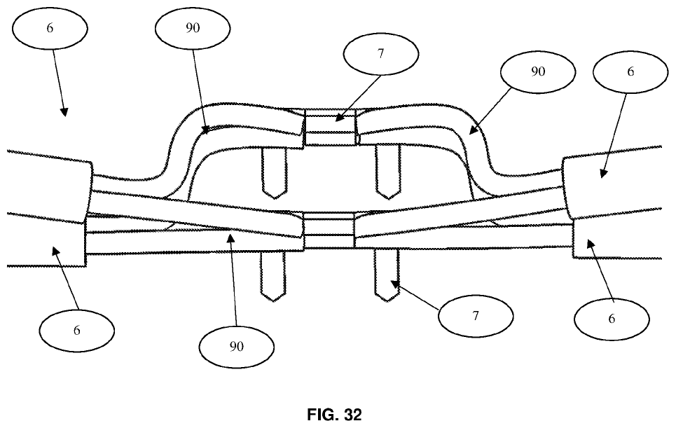

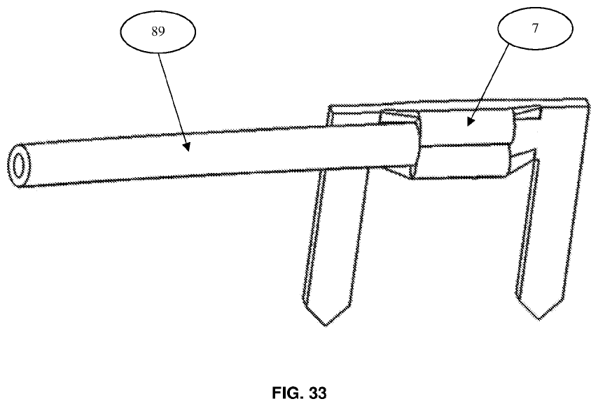

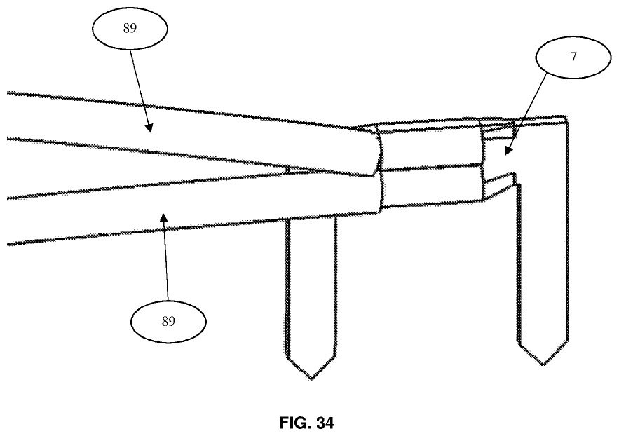

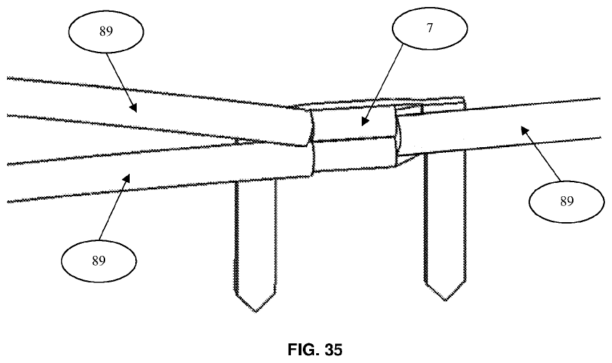

As indicated in FIGS. 30 to 35, a core cable 90 from a multi cored cable 6, or a single core cable 89 (as shown in FIG. 33, for example) may be attached to insulation penetrating contact 7, allowing energy transfer from the contact 7 to the wire 89 or 90, then to the connected apparatus (not shown). The connected core cables 89 or 90 may be connected such that there may be a single cable connected to the insulation penetrating contact 7, or multiple cables connected to the insulation penetrating contact 7, and exiting on one side or both sides of the insulation penetrating contact 7.

Surrounding or encircling the insulation penetrating contact 7 group is a weather seal 8 embedded into the connector mould recess 59 or IDC frame 78 and which protrudes slightly to seal against the flat multi-cored cable jacket 3, creating an upper connector mould assembly 60.

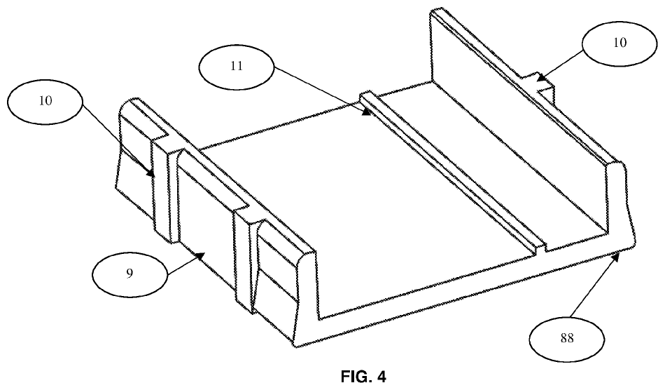

As shown in FIG. 4, a lower base connector mould 9 comprises a polymer mould which contains a moulded cable locating keyway 11 offset from centre to be aligned with and interfaced with the flat multi-cored cable keyway 4. The outer walls of the connector mould 9 comprise asymmetrical keyways 10 to prevent reverse alignment and errant connection. Each lower base connector mould 9 comprises a snap receiver 88 on each side and/or corner to accommodate the snaps 87 of the opposing upper connector assembly mould 5.

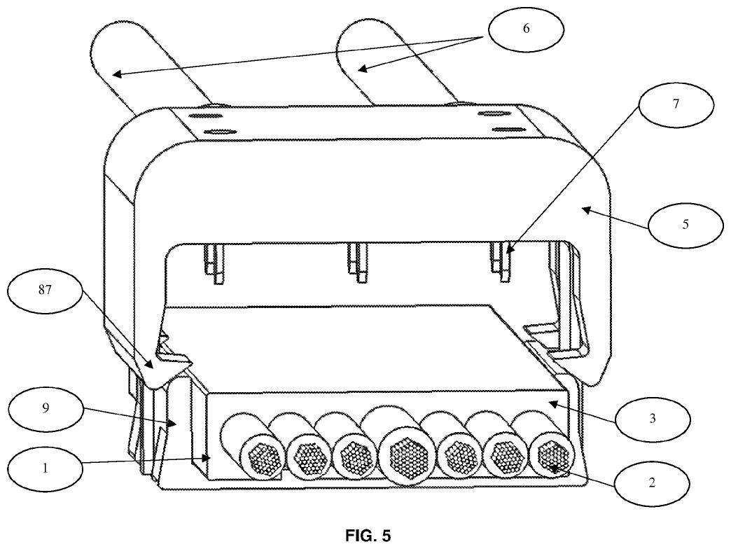

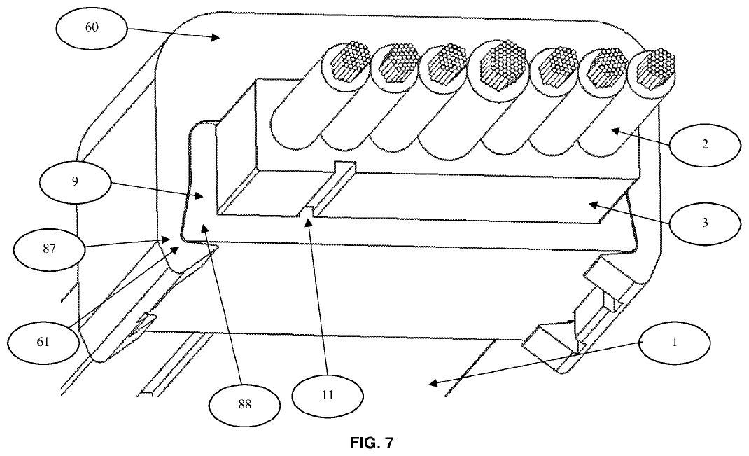

FIG. 5 and FIG. 7 show a lower connector mould 9 which is positioned such that the keyway 4 in the flat multi-cored cable 1 aligns with the cable locating keyway 11. The upper connector assembly 60 is positioned over the bottom connector mould 9 and the flat multi-cored cable 1 such that the asymmetrical keyways 10 of the upper connector mould 60 and lower connector mould 9 are aligned for engagement.

The upper connector assembly 60 is forced down onto the flat multi-cored cable 1 and the lower connector mould 9 causing the side walls containing the keyways and snaps 87 of the upper connector assembly 60 to flex outward while maintaining the correct keyed orientation.

Continued force applied to the top of the upper connector assembly 60 pushes the insulation penetrating contacts 7 through the multi-cored cable jacket 3 and into the inner stranded cable 2 to make electrical contact (not shown in FIG. 5).

The weather seal 8 engages the multi-cored cable jacket 3 face and compresses to form a seal around the contact area (not shown in FIG. 5).

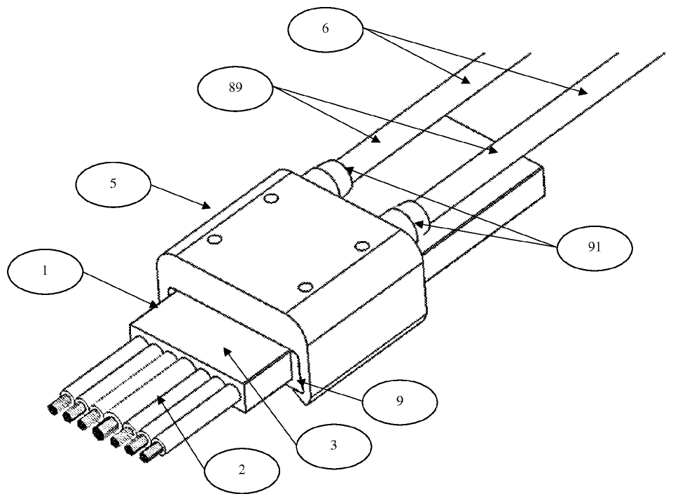

FIG. 6 shows the assembly in its engaged state. The snaps 87 of the upper connector assembly 60 spring back and lock into position 61 of the snap receivers 88 (not visible in FIG. 5 but indicated in FIG. 7), forming a tight connection. The multi-cored cables 6 exiting from the upper connector assemblies 60 may be routed and connected to electrical apparatus such as lights and the like with power consumption not exceeding the rated power of the connector assembly 60.

Also shown in FIG. 6, the multi cored cable 6, or a single core cable 89 exit the connector mould 5 through a transitional cable strain relief outlet 91 protecting the cable 6, 89 or 90 inside the connector mould 5 from excessive strain from tugging, pulling, small bend radii or the like.

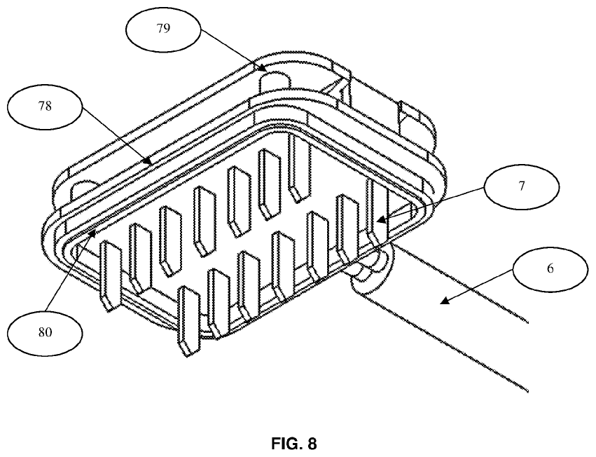

FIG. 8 shows a perspective view of an example insulation displacement connector frame 78 wherein the core cables of a connecting multi-core cable 6 are attached to the insulation penetrating pins 7, and the pins subsequently located in the insulation displacement connector frame 78. A frame cover 79 is applied to form a terminal position assurance wherein the insulation penetrating pins 7 are locked in place.

Also, in FIG. 8 a chamber rib 80 is shown as part of the insulation displacement connector frame 78.

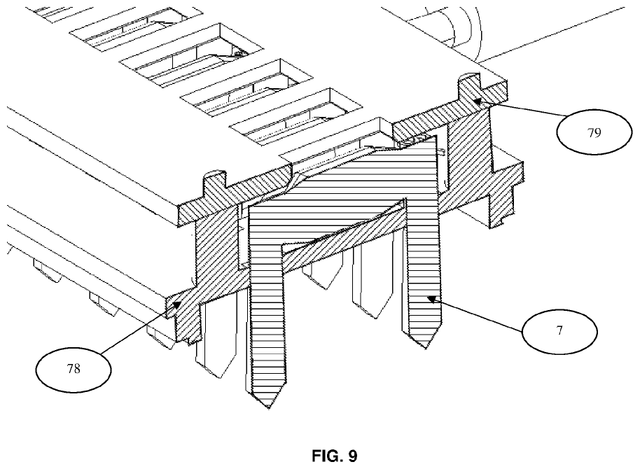

FIG. 9 shows a cross sectional view of the insulation displacement connector frame 78 with the insulation penetrating pins 7 seated within the cavities. The frame cover 79 is shown as being assembled preventing the insulation penetrating pins 7 from backing out of the insulation displacement connector frame 78.

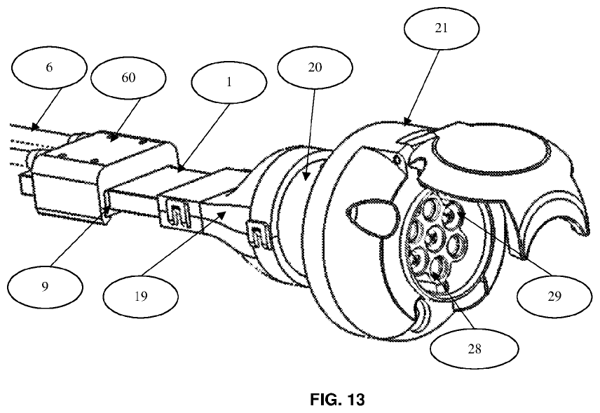

FIG. 13 shows a perspective view of an example round electrical socket 21 (per various standards AS/NZS2513, ISO1185, ISO1724, ISO3731, SAEJ560, SAEJ2863 and the like) between a towing vehicle and a towed vehicle, with flat multi-cored cable 1, strain relief shell 19, and insulation penetrating connector assembly 60, making up part of the overall connection system.

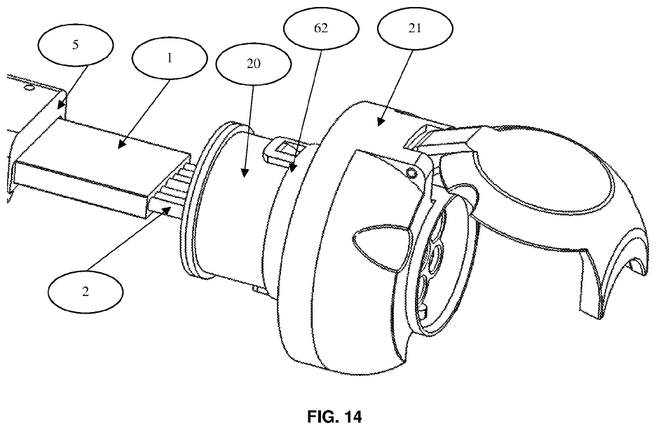

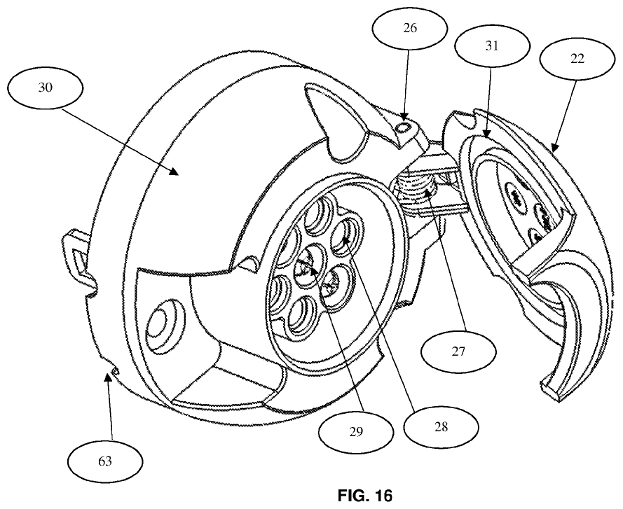

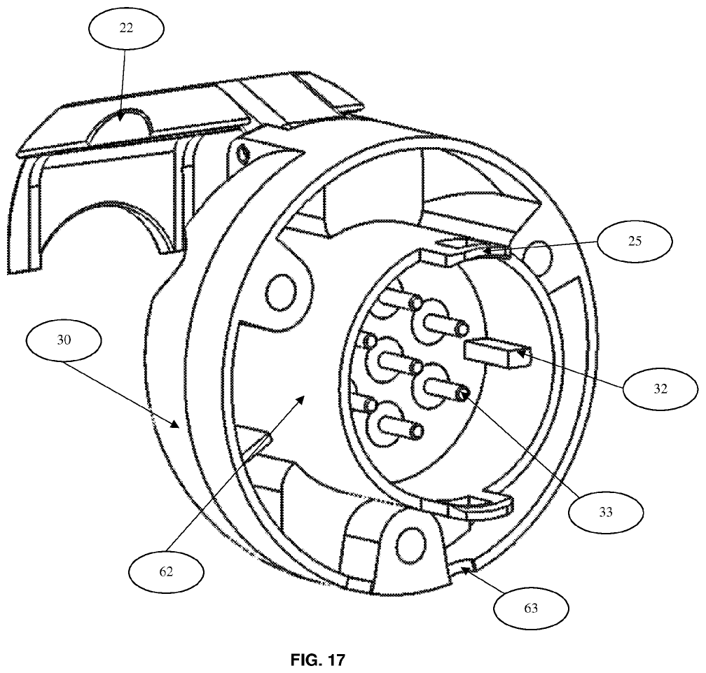

The round socket assembly 21 has an opening at the rear containing electrical contacts 33 (shown in FIG. 17) that feed through to the electrical contacts 28 and 29 at the front of the connector assembly (shown in FIG. 16). A rear housing 62 (shown in FIG. 14) that forms part of the socket assembly 21 surrounds the circumference of the electrical contacts 33.

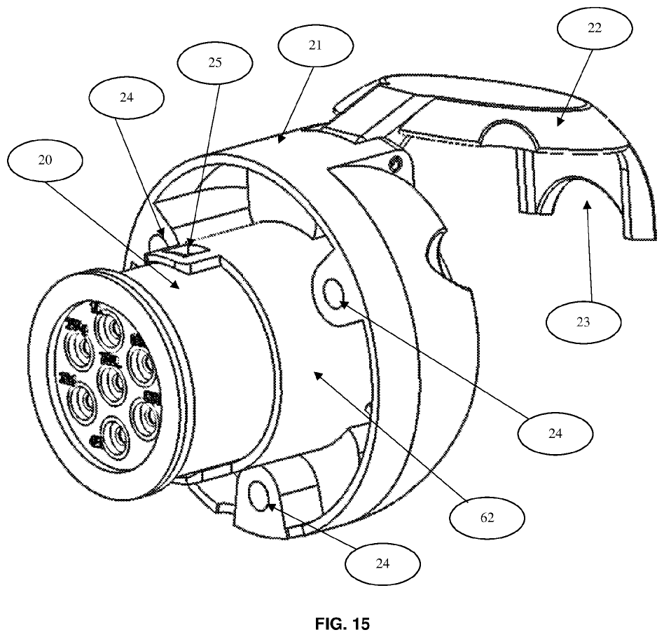

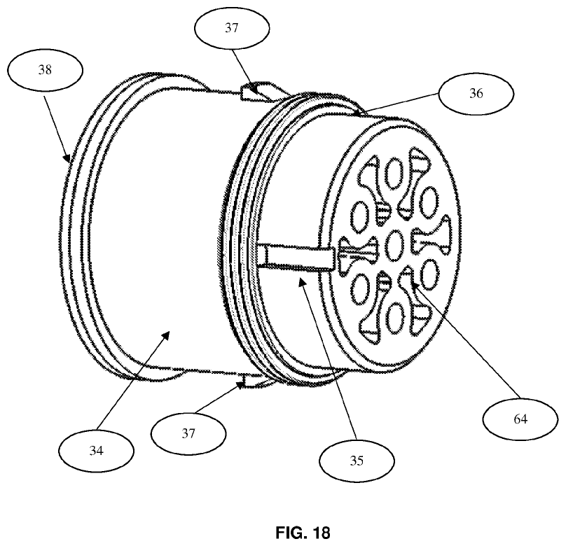

The rear housing 62 contains a keyway 32 which interfaces with a keyway 35 (shown in FIG. 18) on the electrical connector assembly 22 allowing for only one possible correct plugin orientation. The rear housing 62 is equipped with locks 25 (shown in FIG. 15) that engage with the locks 37 (shown in FIG. 18) of the electrical connector assembly 20 keeping the connector assembly 20 retained in the socket assembly 21 so as to maintain electrical contact.

The socket shell 30 (shown in FIG. 16) of the socket assembly 21 has drainage holes 63 (shown in FIG. 16 and FIG. 17) for the release of foreign object debris and liquids, and contains mounting holes 24 (shown in FIG. 15) located circumferentially around the socket shell 30 to accommodate fasteners for mounting the socket assembly 21 to a flat panel.

Referring to FIG. 14, the rear housing 62 allows for a suitable electrical connector assembly 20 to be plugged in to make electrical contact between the flat multi-cored cable 1 and the round connector assembly 21.

Disassembly may be achieved by removing the connector assembly 20 from the socket assembly 21. In doing so, it is necessary to lift both locks 25 (see FIG. 15) located on the socket assembly 21, and to then slide the connector assembly 20 away from the socket assembly 21.

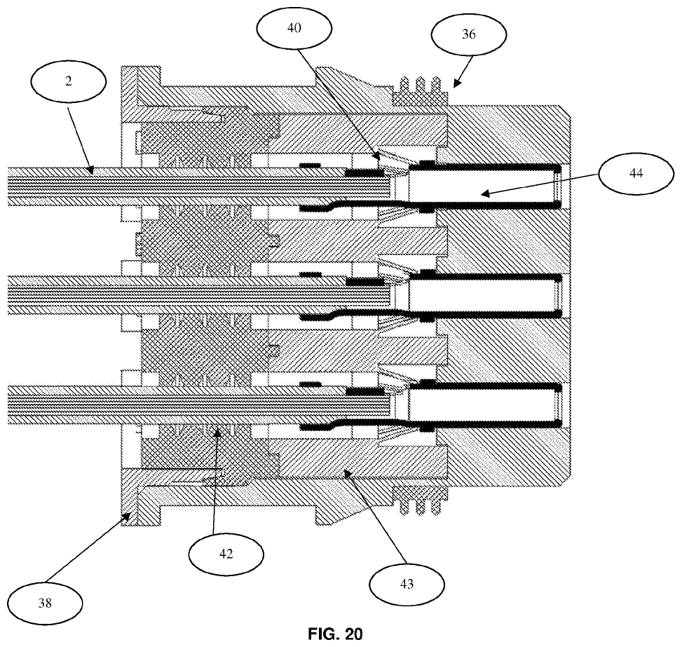

An electrical connector assembly 20 provides a means of conveniently housing a number of electrical contacts 44 (shown in FIG. 20) which are mechanically attached to stranded insulated cable 2 for the purpose of plugging onto a mating connector or to the round connector assembly 21 making an electrical connection.

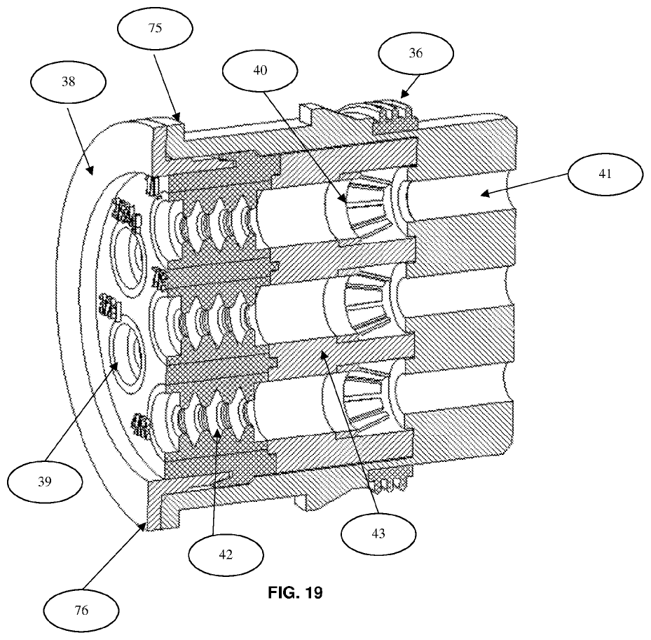

The electrical connector assembly 20 has a main housing 34 (best shown in FIG. 18) made from a rigid polymer which internally holds the electrical contact position insert 64, electrical contact retainer 40 (see FIG. 19), and wire seal 39 which are aligned axially by a keyway 65 (not shown) for correct positioning. The internal parts of the electrical connector 20 are retained in place with a wire seal retainer 38 which is bonded to the main housing 34, and forms an interference fit with the wire seal 39 to deter foreign object debris or liquid ingress.

The electrical connector holds externally an interface weather seal 36 (shown in FIG. 18) made from flexible polymer which engages with the rear housing 62 forming an interference fit to deter foreign object debris or liquid ingress.

A flange 75 on the rear housing 62 and corresponding flange 76 on the wire seal retainer 38 form a lip able to retain a shell, cover, strain relief or the like.

A flexible stranded insulated cable 2 mechanically attached to an electrical terminal 44 (FIG. 20) is inserted through the cavity of the wire seal 39 (FIG. 19) into the contact locator insert 43. Forcing the cable 2 and contact 44 further into the contact locator insert 43 causes the fingers of the contact retainer 40 to deflect outwards, allowing the contact 44 to pass further and enter the contact shaft 41.

The contact 44 is stopped by the rear face of the contact position insert 64 (see FIG. 18) allowing the fingers of the contact retainer 40 to deflect inwards stopping the contact 44 from backing out of the connector assembly 20, thus retaining the contact 44.

An insulated cable 2 of appropriate outer diameter as it passes through the wire seal 39 causes the flexible wire seal material to compress and form a seal around the circumference of the cable 2 or the like, thus forming an interference fit with the wire seal 39 to deter foreign object debris or liquid ingress.

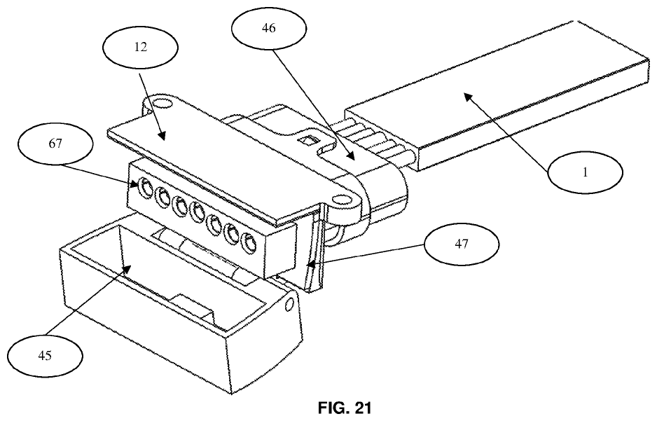

FIG. 21 shows a perspective view of the flat style electrical socket 12 (per various standards AS/NZS 4177.5 and the like) between a towing vehicle and a towed vehicle, with flat multi-cored cable 1, strain relief shell 66 (not shown), and insulation penetrating connector assembly 60 (not shown), thus making up part of the overall connection system.

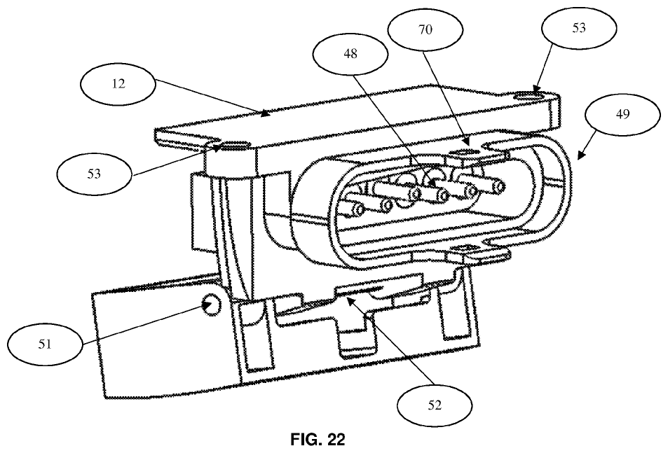

The flat style electrical socket 12 has an opening at the rear containing electrical contacts 48 (shown in FIG. 22) that feed through to the electrical contacts 67 at the front of the connector assembly. A rear shroud 49 that forms part of the flat style electrical socket 12 surrounds the circumference of the electrical contacts 67.

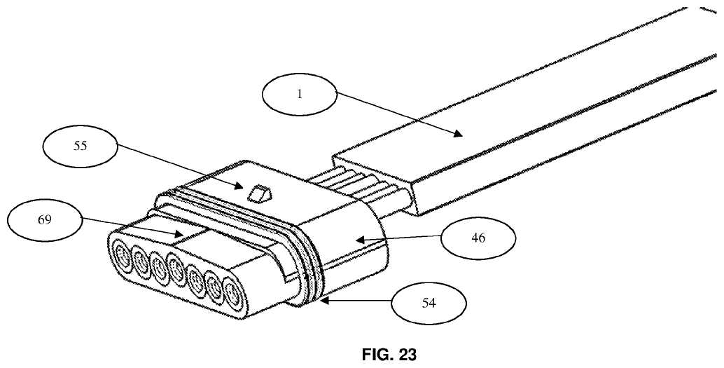

The rear shroud 49 contains a keyway 68 (not visible) which interfaces with the keyway 69 on the electrical connector assembly 46 allowing for only one possible correct plugin orientation. The rear housing 49 is equipped with locking tabs 70 (see FIG. 22) that engage with the locks 55 (see FIG. 23) of the electrical connector assembly 46 keeping the connector assembly 46 retained in the socket assembly 12 and maintaining electrical contact.

As shown in FIG. 22, the socket assembly 12 has mounting holes 53 allowing fasteners for mounting the socket assembly 12 to a flat panel.

The rear housing 49 allows for a suitable electrical connector assembly 46 to be plugged in to make electrical contact between the flat multi-cored cable 1 and the flat style electrical socket 12.

Disassembly may be achieved by removing the connector assembly 46 from the socket assembly 12. In doing so, it is necessary to lift both locks 70 located on the socket assembly 12, and to then slide the connector assembly 46 away from the socket assembly 12.

An electrical connector assembly 46 provides a means of conveniently housing a number of electrical contacts 57 which are mechanically attached to stranded insulated cable 2 for the purpose of plugging onto a mating connector or to the flat style electrical socket 12 making an electrical connection.

The electrical connector assembly 46 has a main housing 72 made from a rigid polymer which internally holds the electrical contact position and electrical contact retainer 73, and wire seal 56 which are aligned axially by an offset wire cavity (not shown) for correct positioning. The internal parts of the electrical connector 46 may or may not be retained in place with a wire seal retainer 71 which is attached to the main housing 72.

External to the electrical connector 46 an interface weather seal 54 is held and it comprises flexible polymer which engages with the rear housing 49 forming an interference fit to deter foreign object debris or liquid ingress.

A flange on the rear housing 72 and/or the cable seal retainer 71 forms a lip able to retain a shell, cover, strain relief or the like.

A stranded insulated cable 2 mechanically attached to an electrical contact 57 is inserted through the cavity of the wire seal 56 into the contact locator and retainer insert 73. Forcing the cable 2 and contact 57 further into the contact locator insert 73 causes the fingers of the contact retainer 73 to deflect outwards, allowing the contact 57 to pass further and enter the contact shaft 74.

The contact 57 is stopped by the internal face of the connector housing 74 allowing the fingers of the contact retainer 73 to deflect inwards stopping the contact 57 from backing out of the connector assembly 46, thus retaining the contact 57.

An insulated cable 2 of appropriate outer diameter as it passes through the wire seal 46 causes the flexible wire seal material to compress and form a seal around the circumference of the cable 2 or the like, thus forming an interference fit with the wire seal 46 to deter foreign object debris or liquid ingress.

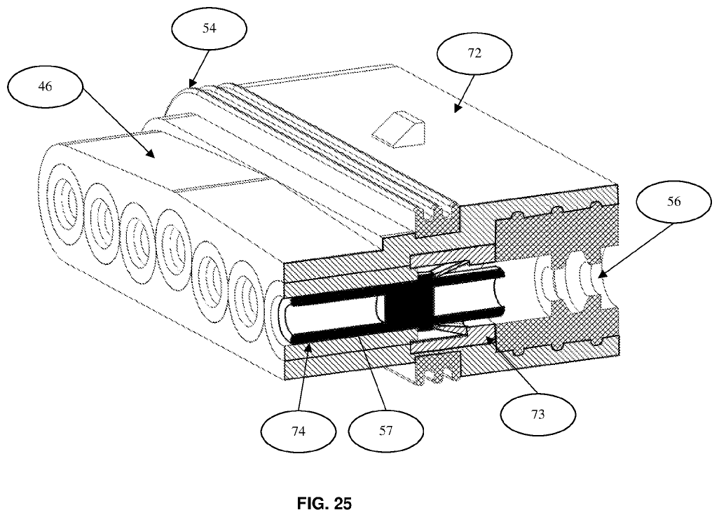

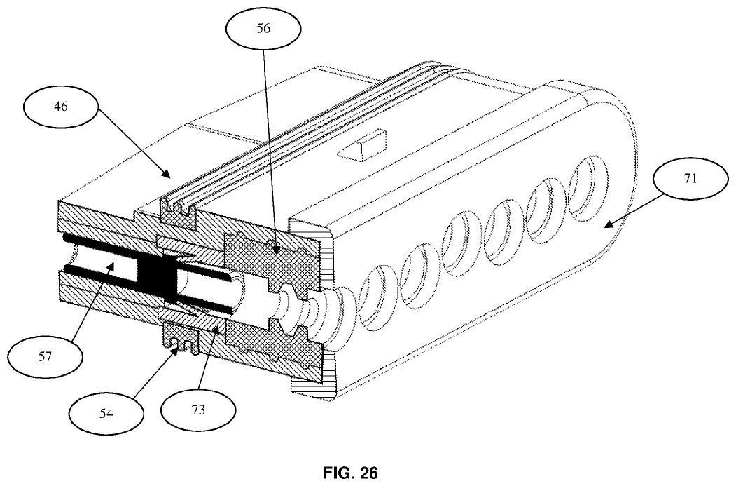

In some instances, a socket or plug may include a magnetic switch, which are connected to electrical contacts. Referring to FIGS. 25 and 26, the electrical contacts 77 of the magnetic switch are shown protruding from the main connector 49. An electrical connector assembly 46 with the corresponding cavities is required to interface to the socket connector 49 to achieve sealed contact.

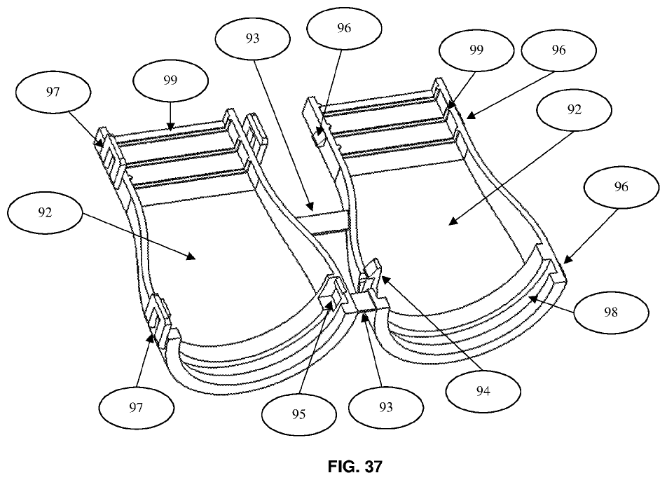

A strain relief back shell accessory 19 (shown in FIG. 13) is used to cover the exposed cables in the transition between an electrical connector 20 and the flat multi-cored cable 1. As shown in FIG. 37, the strain relief back shell 19 may be made of two body halves 92 connected by a hinge 93 allowing the body halves 92 to come together come together to from a circumferential cover.

The back shell 19 interfaces with the electrical connector 20 by locating the flange 71 and 72 (not shown in FIG. 37) of the electrical connector 20 into the groove 98 provided. The back shell 19 further interfaces with the flat multi-cored cable 1 by creating an interference fit between the cable jacket 3 (not shown in FIG. 37) and the back shell ribbing 99, creating a grip on the cable jacket.

The back shell 19 is held together by multiple snap locks. As the back shell 19 is folded, a snap 94 engages with a snap receiver 95 beginning the locking process. Continuing to fold the back shell 19, the remaining snaps 96 lock into snap receivers 97 completing the locking process, and forming a fully locked circumferential cover.

Specific exemplary cable, connection and harness combinations that are suitable for embodiments of the present invention are as follows:

### Cables:

7 core flat cable with index and keyway
5 core flat cable with index and keyway
2 core round cable
3 core round cable
5 core round cable
7 core square cable with index and keyway
5 core square cable with index and keyway
7 core rectangular cable with index and keyway
5 core rectangular cable with index and keyway
   IDC connections:
Single outlet Marker IDC connection
Dual outlet Marker IDC connection
Single outlet Left hand indicator IDC connection
Dual outlet Left hand indicator IDC connection
Single outlet Right hand indicator IDC connection
Dual outlet Right hand indicator IDC connection
Single outlet Left+Right hand indicator IDC connection
Dual outlet Left+Right hand indicator IDC connection
Single Outlet combination light IDC connection (Left hand side)
Dual Outlet combination light IDC connection (Left hand side)
Single Outlet combination light IDC connection (right hand side)
Dual Outlet combination light IDC connection (Right hand side)
Single Outlet combination light IDC connection (Left+Right hand)
Dual Outlet combination light IDC connection (Left+Right hand)
Single Outlet brake/tail light IDC connection
Dual Outlet brake/tail light IDC connection
Single Outlet reverse/backup light IDC connection
Dual Outlet reverse/backup light IDC connection
IDC connection base

### Harness Connections:

7 pin flat socket with harness connector interface
12 pin flat socket with harness connector interface
7 pin round socket with harness connector interface
5 pin round socket with harness connector interface
7 pin flat sealed harness connector
12 pin sealed harness connector
7 pin round sealed harness connector
5 pin round sealed harness connector
7 pin flat socket with harness connector interface and magnetic switch contacts
12 pin flat socket with harness connector interface and magnetic switch contacts
7 pin round socket with harness connector interface and magnetic switch contacts
5 pin round socket with harness connector interface and magnetic switch contacts
7 pin flat sealed harness connector compatible with magnetic switch contacts
12 pin sealed harness connector compatible with magnetic switch contacts
7 pin round sealed harness connector compatible with magnetic switch contacts
5 pin round sealed harness connector compatible with magnetic switch contacts
Flat back shell to suit flat 7 pin harness connector
Flat back shell to suit flat 12 pin harness connector
Round back shell to suit round 7 pin harness connector
Round back shell to suit round 5 pin harness connector
Cable Sealing End Cap (7 core flat cable)
Cable Sealing End Cap (5 core flat cable)
Cable Sealing End Cap (7 core square cable)
Cable Sealing End Cap (5 core square cable)
Cable Sealing End Cap (7 core rectangular cable)
Cable Sealing End Cap (5 core rectangular cable)
Cable Sealing End Cap with mount (7 core flat cable)
Cable Sealing End Cap with mount (5 core flat cable)
Cable Sealing End Cap with mount (7 core square cable)
Cable Sealing End Cap with mount (5 core square cable)
Cable Sealing End Cap with mount (7 core rectangular cable)
Cable Sealing End Cap with mount (5 core rectangular cable)
Mounting clamp (7 core flat cable)
Mounting clamp (5 core flat cable)
Mounting clamp (7 core square cable)
Mounting clamp (5 core square cable)
Mounting clamp (7 core rectangular cable)
Mounting clamp (5 core rectangular cable)

The following is a discussion on the results of trials and experiments that have been conducted in the development of embodiments of the present invention to test the veracity of the present invention.

3D printed parts of initial concepts were produced in order to review size and fitment before moving into manufactured prototypes of cable and IDC clamps.

Various trial connections of IDC connections were installed on a typical haulage semi-trailer vehicle for on road/real world testing and validation of the concept alongside an existing trailer harness for electrical connections. To achieve sealing around pins, dielectric grease derived from lanolin was installed on the connections before being secured on the cable. The particular rig with the trailer installed travelled interstate over an 18-month period with no failures reported in its 100,000 km+ journey. Upon removing the experimental harness from the trailer, the connectors were reviewed for any wear, water & dust ingress, with no visible signs of failure.

Finite Element Analysis (FEA) has been conducted on parts for reviewing where weak points are likely to be, which has resulted in optimization of the affected area. Various testing included, an inspection of a trial harness that was installed on a trailer for 12+ months of ‘on-road’ use. Trial harness was experimented with submerged cables to determine water ingress opportunity, and experiments were conducted with sealing options.

Experiment and validation of early prototypes were also carried out by way of the following examples as set out below.

### Example 1—In Situ Test of IDC Connectors

### Intent:

To test the application of the system alongside an existing conventional trailer wiring system to test for continued connectivity when subjected to normal vibration, water, dust of a standard semi-trailer.

### Materials:

IDC connection system
Flat 7 core cable
AS/NZS 2513 7 pin round trailer socket
Lanolin based dielectric grease
Cable Ties
LED marker & indicator lamps

### Method:

1. Run the flat 7 core cable parallel with the existing wiring harness.
2. Fit off 7 pin trailer socket at the front of the trailer for truck connection.
3. Splice in cables for the rear lights.
4. Fit lanolin based dielectric grease to the pins to create a water-resistant sealing
5. Fit off marker and indicator IDC connectors as required.
6. Connect IDC connection wiring to lights on curtain rail.
7. Tie back cables, ensuring there is no slack.
8. Run the trailer for an extended period to ensure the harness gets the same treatment as the existing wiring harness.

### Results:

An early version experimental harness was fitted to a haulage trailer that was often travelling via highway between Adelaide and Melbourne, a distance of between about 730 km and about 750 km. Harness was fitted to the trailer by an approved Auto Electrician. The harness was removed from the trailer and reviewed for damage. The trailer was reported to have done at least 100,000 km in an 18-month period, without any instance of failure of the system. Inspection showed the harness was covered in a thick layer of FOD (Foreign Object Debris) made up mostly of dirt, mixed with liquid, or grease from being exposed to the road surface. FOD had entered the IDC system connector area along the cable keyway side, which was not protected by a seal, and along the terminal side, which was protected around the terminals by the lanolin based dielectric grease.

Upon removal of the protective jacket around the crimped sections of the flat 7 core cable, this showed no visible signs of water or dirt entry into the wire area. Furthermore, removal of the inner cable insulation showed that there were no visible signs of oxidisation of the copper strands, meaning water had not come into contact with the strands at all. It was also notable that the IDC pins of the IDC system had pierced through the centreline of the stranded inner cable as intended.

Repeating the same method of removal at other IDC system connection locations along the flat cable showed that some of the IDC system connectors appeared to be misaligned with at least one of the IDC pins deflecting away from the centre axis of the cable. This caused the pin to still be connected in one position along the axis, but miss the cable altogether at the other pin.

Inspecting one area of the inner cable where the IDC pins had pierced, the strands were reviewed under a microscope, and shown to have accumulated a minute amount of FOD, possibly causing an eventual reduction in conductivity or discontinuity between the pin and strands. As the IDC system connectors had all been removed from the cable prior to receiving it back from its decommissioning in the field test, it is not known if the FOD had occurred before, during or after the removal.

When the IDC system connectors were removed for review, it was found that the lanolin based dielectric grease has been compressed into a uniformly flat area surrounding the terminals creating a water barrier. This was as intended. The grease was still soft and pliable and had not worn away. Removal of the IDC system connectors had caused some of the dielectric grease to be removed or an amount transferred to the surface of the flat 7 core cable.

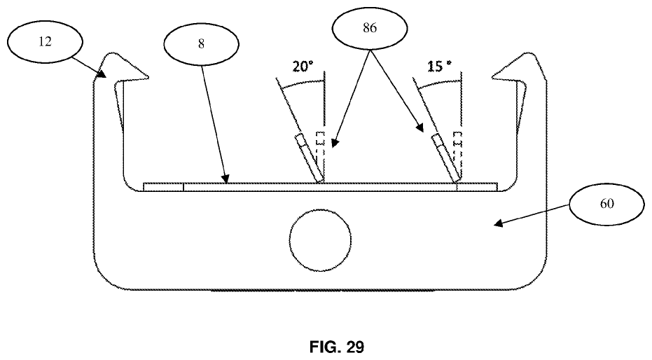

Some of the connectors showed damage to the 2-core cable where they are moulded into the connector, highlighting a possible weak point when the cable is flexed. Some of the IDC system connectors also showed terminal damage where the terminals had been bent or deflected up to 20° from their initial perpendicular to the surface. This is shown in FIG. 29. This may have come from either the application process where IDC system connectors were not correctly aligned, or from the removal process.

It was concluded from the experiment of Example 1 that the connector was hard to fit and would benefit from having extra chamfers on mating surfaces to allow parts to align and mate more easily but still maintain the locking features. The terminal was easily bent if the parts were not aligned properly, so a terminal with a different shape, or a different material, or one that had better lead in geometry may solve these problems. It was envisaged that a fit for purpose tool would provide for easier installation. With respect to the connector moulds, it was concluded that having a round cable may be easier to work with to shut off as opposed to the rectangular (flat) 2 core cable.

### Example 2—Water Ingress of IDC System Connectors—Silicone Gel

### Intent:

To test water ingress of an IDC system connector to determine a suitable level of sealing with various sealing compounds to achieve IP65 or better protection of a static connection.

### Materials:

IDC system connectors
flat 7 core cable
2-part silicone gel
RTV Gasket maker
Container to hold water
Salt Water
Food colouring-Red

### Method:

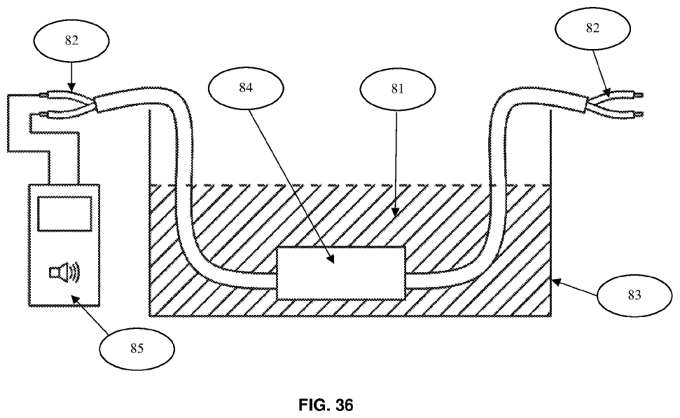

1. Mix sealing compound to manufacturers specification.
2. Apply sealant to recessed area around IDC system connector terminal cavity ensuring not to coat the terminal.
3. Allow sealant to cure for the recommended time.
4. Cut and prepare 250 mm lengths of flat 7 core cable.
5. Jacket ends to be cut, to allow an insulating material (e.g., paper) to be inserted between wires to stop them from shorting.
6. Crimp IDC system connector onto the middle of the flat 7-core cable ensuring connector is correctly located with keyways.
7. Label cables with the method of sealing.
8. Continuity test the connected wires to ensure continuity end to end of flat 7 core cable, and continuity of flat 7 core cable to 2 core cable on the connector.
9. Continuity check all connections to ensure that there is no direct short circuit between any of the wires.
10. Fill a container of water to a depth of 60 mm+/−10 mm. Salt water is used to ensure better electrical connection between components if there is a short circuit due to the existing ions.
11. Add food dye to the container to change the colour of the water to a noticeable colour.
12. Submerge the IDC system connector fully in the water, with all wire ends out of the water. FIG. 36 shows appropriate submersion.
13. Recheck continuity of all connected wires for continuity and short circuits.
14. Leave submerged for 1 week (i.e., 5 working days) checking the continuity every day.
15. After being submerged for 1 week, remove from the container and dry any excess water with paper towel.
16. Carefully remove the IDC system connector from the flat cable and review geometry for any signs of water ingress.
17. Note any results.

### Results:

Using a 2-part silicone gel mixed to 1:1 ratio as indicated by datasheet, the sealant was applied to connector and allowed to cure. Day 0; prepared in accordance with method. Continuity OK, all working correctly. No short circuits. No signs of water wicking up cables. Day 3:—Continuity OK, all working correctly. No short circuits. No signs of water wicking up cables. Day 4:—Continuity OK, all working correctly. No short circuits. No signs of water wicking up cables. Day 5:—Continuity OK, all working correctly. No short circuits. No signs of water wicking up cables. Day 6:—Continuity OK, all working correctly. No short circuits. No signs of water wicking up cables. Day 7:—Continuity OK, all working correctly. No short circuits. No signs of water wicking up cables. Test piece removed from water and dried with paper towel. IDC system clamp removed from flat 7 core cable & observed water ingress into the IDC system connector area that was not sealed or in contact with the silicone gel. Water was evident on base plate and on keyway side of the 7-core cable as expected as this is not a sealed part.

Water appearance was noted on terminal side of clamp, but not within the sealed terminal area where the gel was. Water had pooled on the top side of the cable around the area where the gel touched the cable. There appeared to be no water at the points where the pins displace the cable jacket on the flat 7 core cable.

Upon opening a window of the flat 7-core jacket, there were no visible signs of water entry, indicating that the gel has sealed around the terminal area. With the complete removal of the jacked on the terminated area, there were no visible signs of water ingress on the front or on the back sides of the wires.

In conclusion for Example 2, it was noted the silicone gel flowed neatly into the recessed area of the connector, and surprisingly adhered to the brass terminal making a trapezoidal seal part way up the terminal. The gel did not have sufficient surface tension to create a seal higher than the recess, so the gel seal working area was very thin. Silicone gel was Quick curing resulting in soft pliable seal. On inspection of the removed IDC system connector, the water is shown to be around the contact area but did not appear to be on the contacts or in the copper cable strands. The silicone gel was a partial success as the water did not ingress too far as to affect the function under a static test. Cured gel is easy to remove from its location with a small amount of force, and splits under tension, so it may not be appropriate to use.

### Example 3—Water Ingress of IDC System Connectors—Gasket Maker

### Intent:

To test water ingress of an IDC system connector to determine suitable level of sealing with various sealing compounds to achieve IP65 or better protection of a static connection.

### Materials:

RICS IDS connection system
RICS 7 core cable
Blue RTV Gasket maker
Container to hold water
Salt Water
Food colouring-Red

### Method:

1. Apply sealant around recessed area around the IDC system connector ensuring not to coat the terminal
2. Allow sealant to cure or skin for the recommended time
3. Cut and prepare 250 mm lengths of flat 7 core cable.
4. Jacket ends to be cut, to allow an insulating material (paper) to be inserted between wires to stop them from shorting.
5. Apply IDC system connector onto the middle of the flat 7-core cable ensuring connector is correctly located with keyways.
6. Label cables with the method of sealing
7. Continuity test the connected wire to ensure continuity end to end of 7 core cable, and continuity of 7 core cable to 2 core cable on the connector.
8. Continuity check same connections to ensure that there is no direct short circuit between any of the wires.
9. Fill a container of water to a depth of about 60 mm+/−10 mm. Salt water will be used to ensure better electrical connection between components if there is a short circuit due to the existing ions.
10. Add food dye to the container to change the colour of the water to a noticeable colour.
11. Submerge the IDC system connector fully in the water, with all wire ends out of the water. FIG. 36 illustrates appropriate submersion.

### Results:

The IDC connector halves needed to be cable tied together as compressing the sealant required a lot of force, eventually deforming the locking tabs of the connectors, stopping the connector halves from fully engaging. The assembly was continuity checked before being submerged, with no sign of shorting. One (1) minute after submerging, a test was conducted on the continuity, which showed that there was a short between the connected pins. The continuity alarm changed from an audible sound on the normally connected wires to a far less audible sound across the wires that should normally be isolated from each other. This indicated that there was a high resistance path directly between the pins, and that the test had failed. As expected, water was able to enter the lower half of the connector that is not sealed but has no electrical connection. Water ingress was evident on the top side of the cable, on and around the terminal entry points. This caused the terminals to become connected by the salt water and short together. The top half of the clamp showed water ingress past the seal, with water pooling around the terminals.

In conclusion for Example 3, the Blue RTV sealant itself was hard to apply due to its viscosity, though it adhered very well to the plastic substrate of the connector. Once cured, the RTV was semi-hardened with only a small amount of flexibility. Compressing the cable and the connector halves together was difficult due to the amount of force needed to compress the RTV sealant. The Blue RTV ultimately failed as it allowed water to seep in, shorting the terminals rapidly after immersion. As the RTV was difficult to apply, the shape of the seal was not uniform. It is envisaged that if it was a uniform shape with homogeneous surface, and lower hardness, it may fare a lot better.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above-described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, any means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

The following sections I-VII provide a guide to interpreting the present specification.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this specification”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a symbol, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology Are Not Limiting

Neither the Title nor the Abstract in this specification is intended to be taken as limiting in any way as the scope of the disclosed invention(s). The title and headings of sections provided in the specification are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognise that the disclosed invention(s) may be practised with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, operations, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more micro-controllers, one or more digital signal processors) will receive instructions (e.g., from a memory or like device), and execute those instructions, thereby performing one or more processes defined by those instructions.

A “processor” means one or more microprocessors, central processing units (CPUs), computing devices, micro-controllers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fibre optics, including the wires that comprise a system bus coupled to the processor. Transmission media may include or convey acoustic waves, light waves and electromagnetic emissions, such as those generated during radio frequency (RF) and infra-red (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviours of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices that are adapted to communicate with the computer. Any number and type of devices may be in communication with the computer.

In an embodiment, a server computer or centralised authority may not be necessary or desirable. For example, the present invention may, in an embodiment, be practised on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer and for that matter, any commercial processor may be used to implement the embodiments of the invention either as a single processor, serial or parallel set of processors in the system and, as such, examples of commercial processors include, but are not limited to Merced™, Pentium™ Pentium II™, Xeon™, Celeron™, Pentium Pro™, Efficeon™, Athlon™, AMD™ and the like), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML. Moreover, there are hundreds of available computer languages that may be used to implement embodiments of the invention, among the more common being Ada; Algol; APL; awk; Basic; C; C++; Conol; Delphi; Eiffel; Euphoria; Forth; Fortran; HTML; Icon; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Visual Basic; Visual C++; Linux and XML.) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL). Hardware logic may also be incorporated into display screens for implementing embodiments of the invention and which may be segmented display screens, analogue display screens, digital display screens, CRTs, LED screens, Plasma screens, liquid crystal diode screen, and the like.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

We claim:

1. An insulation-displacement connection adapted for engagement with a first multi-core cable for wiring electrical components operatively associated with a vehicle and a trailer wherein the insulation-displacement connection comprises an insulation penetrating electrical contact adapted for engagement with a corresponding set of flexible, stranded insulated core cables of the first multi-core cable wherein the insulation penetrating electrical contact comprises a set of penetrating tabs each set for engaging individual flexible, stranded insulated core cables of the first multi-core cable and each comprising at least two insulation penetrating pins.

2. An insulation-displacement connection as claimed in claim 1, wherein integral parts of the insulation displacement connection form an upper connector mould assembly, the assembly comprising:
locking mechanisms that are integral with a connector housing for locking with an opposing connector base plate, and;
orientation keying mechanisms for facilitating orientation for assembly with opposing connection portions.

3. An insulation-displacement connection as claimed in claim 1 adapted for engagement with at least a first multi-core cable for wiring electrical components operatively associated with a vehicle and a trailer wherein the insulation-displacement connection comprises at least one insulation penetrating contact with insulation penetrating pins uniquely indexed so as to map to a corresponding set of stranded insulated core cables of the first multi-core cable.

4. An insulation-displacement connection as claimed in claim 1, wherein the at least one insulation penetrating contact comprises:
a plated or un-plated, high strength electrically conductive material;
a conductor attachment area for electrical contact with at least a second connecting single-core or multi-core cable;
a conductor contact area aligning with stranded conductors of the first connecting multi-core cable;
a penetrating tab integral with the insulation penetrating pins, and;
a penetrating point integral with the insulation penetrating pins.

5. An insulation-displacement connection as claimed in claim 1, wherein the penetrating tab comprises a contact area on one or both of a front face and a rear face of the insulation penetrating contact for making electrical contact with one or more of the stranded insulated core cables of the first multi-core cable.

6. An insulation-displacement connection as claimed in claim 1, wherein the penetrating tab includes a deflection ramp on either or both a front face and a rear face of the insulation penetrating contact to reduce deflection of the penetrating pins upon piercing contact with the indexed insulated core cables of the first multi-core cable.

7. An insulation-displacement connection as claimed in claim 3, wherein the penetrating tab includes insulation penetrating pins comprising a high strength copper or alloy thereof.

8. An insulation-displacement connection adapted for engagement with a multi-core cable for wiring electrical components operatively associated with a vehicle and a trailer wherein the insulation-displacement connection includes a frame to accommodate the insulation-displacement pins as claimed in claim 1 to;
space respective insulation-displacement connection pins;
retain the insulation-displacement connection pins to provide consistent pin depth;
facilitate locating the insulation-displacement connector into an injection mould tool for manufacturing, and;
reduce the volume of the insulation-displacement connection occupied during manufacture.

9. An insulation-displacement connection as claimed in claim 1 adapted for engagement with a multi-core cable for wiring electrical components operatively associated with a vehicle and a trailer wherein the insulation-displacement connection includes a connector frame that comprises;
at least one cavity for seating insulation displacement connections;
a frame cover for maintaining insulation displacement connection location and depth;
a recess for locating a flexible weatherproof seal, and;
a raised rib encircling the seal and contact area of the insulation displacement connection.

10. An insulation-displacement connection as claimed in claim 9 adapted for engagement with a multi-core cable wherein a weather seal is embedded into a recess of the connector frame and/or housing mould to form an upper connector mould assembly upon sealing engagement against a jacket of the first multi-core cable.

11. An insulation-displacement connection as claimed in claim 10 for wiring electrical components operatively associated with a vehicle and a trailer adapted for engagement with a multi-core cable wherein the insulation-displacement connection comprises an integrated flexible weather seal which seals between the connection and individual cable faces of the first multi-core cable.

12. An insulation-displacement connection as claimed in claim 1, wherein an integrated flexible weather seal is configured to encircle insulation penetrating pins protruding from a connection housing mould of the insulation-displacement connection and protrude from the connection housing mould for sealing engagement against a jacket of the first multi-core cable.

13. An insulation-displacement connection as claimed in claim 1 adapted for engagement with a multi-core cable for wiring electrical components operatively associated with a vehicle and a trailer wherein the insulation-displacement connection body comprises:
at least one cable strain relief outlet, and;
at least one single-core or multi-core cable for connection to electrical apparatus.

14. An insulation-displacement connection as claimed in claim 1, wherein a base plate is configured to engage with the insulation-displacement connection, and comprises at least one longitudinal keyway moulded into the base plate corresponding to a keyway moulded into a first multi-core cable for mating connection between the multi-core cable and the connection base plate.

15. An insulation-displacement connection as claimed in claim 14, wherein the at least one keyway is disposed in an asymmetric configuration with respect to one or more of the first multi-core cable and the connection.

16. An insulation-displacement connection as claimed in claim 1 adapted for engagement with at least a first multi-core cable for wiring electrical components operatively associated with a vehicle and a trailer wherein the insulation-displacement connection comprises;
at least three form factor variations of the insulation displacement connector assembly with respect to the insulation piercing contact index locations to accommodate different connected electrical apparatus comprising one or a combination of left indicator lights, right indicator lights, tail lights, brake lights, reverse lights, marker lights, combination lights, and;
at least two variations of the number of cable outlets to accommodate single or multiple connections to electrical apparatus.

17. An insulation-displacement connection as claimed in claim 16, wherein the first multi-core cable comprises;
one or more of flexible, stranded, insulated inner cores that are indexed to match respective penetrating pins;
one or more of flexible, stranded, insulated inner cores that are adapted to conform to size, colour and type characteristics of one or more regulated standards
an outer insulating jacket to house and protect the flexible, stranded, insulated inner cores which is adapted to conform to characteristics of one or more regulated standards;
one of a flat, square, or rectangular profile, adapted to access and connect to the indexed flexible, stranded, insulated cores, and;
a moulded keyway to interface with the insulation displacement connection base plate.

18. A system for connection of a first multi-core cable for wiring electrical components operatively associated with a vehicle and a trailer, the system comprising:
an insulation-displacement connection as claimed in claim 1;
a socket associated with the vehicle or the trailer wherein the socket comprises;
at least one side for operatively engaging with a standard trailer plug, and;
at least one side for operatively engaging with a weatherproof sealed connection.

19. A socket connection for use in the system of claim 18 where the socket connection is associated with one of a vehicle or a trailer and comprises:
a main housing of synthetic material for housing multigender terminals corresponding to a form factor so as to make contact with a standard plug connector at one end thereof and an electrical connector at another end thereof;
a magnetic switch operably connectable to electrical contacts protruding from a main connector of the socket, and/or;
an integrated terminal cover and plug connector lock, having a splash proof seal;
a cover pivot pin;
at least one cover torsion spring to either force the cover to seal against the socket housing, or force the cover onto the standard plug connector;
at least two integrated mounting holes for securing the socket connector to a substrate, and;
at least one drainage hole for the release of foreign object debris and/or liquids.

20. A socket connection associated with one of a vehicle or a trailer as claimed in claim 18, wherein the socket connection comprises single and/or multigender feedthrough electrical terminals embedded in the socket connection operably associated with mating to the standard plug connector and the weatherproof sealed connector, wherein the feedthrough electrical terminals comprise;
socket-to-Pin gender, or;
Pin-to-Pin gender, and;
at least one central flange for locking into the socket connection housing, and;
plated or un-plated high strength electrically conductive material,

21.-44. (canceled)
